(19) United States
(12) Patent Application Publication
(10) Pub. No.: US 2025/0363733 A1
(43) Pub. Date: Nov. 27, 2025

(54) GENERATION APPARATUS, GENERATION METHOD, REPRODUCTION APPARATUS, AND REPRODUCTION METHOD

(71) Applicant: Sony Group Corporation, Tokyo (JP)

(72) Inventor: Toshiya HAMADA, Saitama (JP)

(73) Assignee: Sony Group Corporation, Tokyo (JP)

(21) Appl. No.: 18/874,908

(22) PCT Filed: May 23, 2023
(86) PCT No.: PCT/JP2023/019086

§ 371 Date: Dec. 13, 2024

(30) Foreign Application Priority Data
Jun. 30, 2022 (JP) 2022-105475

(51) Int. Cl. G06T 17/00

(52) U.S. Cl. CPC G06T 17/00

(57) ABSTRACT

A generation apparatus according to an embodiment of the present technology includes a generation section. The generation section generates three-dimensional spatial data used in rendering processing executed to represent a three-dimensional space and including sensory representation metadata for representing at least one of a temperature or surface roughness with respect to a component of a scene configured by the three-dimensional space. This makes it possible to greatly simplify the representation of the temperature and the surface roughness in the three-dimensional virtual space, thereby reducing a processing load. As a result, it becomes possible to realize a high-quality virtual video.

### TECHNICAL FIELD

The present technology relates to a generation apparatus, a generation method, a reproduction apparatus, and a reproduction method applicable to broadcasting of VR (Virtual Reality) videos and the like.

### BACKGROUND ART

In recent years, 360-degree videos that have been taken by a 360-degree camera and the like and can view in all directions are starting to be broadcasted as VR videos. In addition, recently, development of a technology of broadcasting 6DoF (Degree of Freedom) videos (also called 6DoF content) with which viewers (users) can look all around (freely select a direction of a line of sight) and freely move within a 3D space (can freely select a viewpoint position) is in progress.

In order to construct a three-dimensional virtual space on a computer that is so realistic that it is indistinguishable from a real space, it is also important to reproduce stimulation to other senses in addition to a sense of sight and a sense of hearing. Patent Literature 1 discloses a technology for reproducing a sense of tactile that can suppress an increase in a load of haptics data transmission.

### CITATION LIST

### Patent Literature

Patent Literature 1: International Patent Publication No. 2021/172040

### DISCLOSURE OF INVENTION

### Technical Problem

Broadcasting of an imaginary video (virtual video), such as a VR video, is thought to become popular, and there is a need for technology that can realize a high-quality virtual video.

In view of the circumstances described above, an object of the present technology is to provide a generation apparatus, a generation method, a reproduction apparatus, and a reproduction method that can realize the high-quality virtual video.

### Solution to Problem

In order to achieve the above-mentioned object, a generation apparatus according to an embodiment of the present technology includes a generation section.

The generation section generates three-dimensional spatial data used in rendering processing executed to represent a three-dimensional space and including sensory representation metadata for representing at least one of a temperature or surface roughness with respect to a component of a scene configured by the three-dimensional space.

In the generation apparatus, the three-dimensional spatial data including the sensory representation metadata that represents at least one of the temperature or the surface roughness with respect to the component of the scene configured by the three-dimensional space is generated. This makes it possible to realize a high-quality virtual video.

The three-dimensional spatial data may include scene description information that defines a configuration of the three-dimensional space and three-dimensional object data that defines a three-dimensional object in the three-dimensional space. In this case, the generation section may generate at least one of the scene description information including the sensory representation metadata or the three-dimensional object data including the sensory representation metadata.

The generation section may generate the scene description information including at least one of a basic temperature or basic surface roughness of the scene configured by the three-dimensional space as the sensory representation metadata.

The three-dimensional object data may include video object data that defines the three-dimensional video object in the three-dimensional space. In this case, the generation section may generate the scene description information including at least one of a basic temperature or basic surface roughness of the three-dimensional video object as the sensory representation metadata.

The three-dimensional object data may include the video object data that defines the three-dimensional video object in the three-dimensional space. In this case, the generation section may generate at least one of a temperature texture for representing the temperature or a surface roughness texture for representing the surface roughness as the sensory representation metadata with respect to a surface of the three-dimensional video object.

The video object data may include a normal texture used to visually represent the surface of the three-dimensional video object. In this case, the generation section may generate the surface roughness texture on the basis of the normal texture.

A data format of the scene description information may be a glTF (GL Transmission Format).

The three-dimensional object data may include the video object data that defines the three-dimensional video object in the three-dimensional space. In this case, the sensory representation metadata may be stored in at least one of an extension area of a node corresponding to the scene configured by the three-dimensional space, an extension area of a node corresponding to the three-dimensional video object, or an extension area of a node corresponding to a surface state of the three-dimensional video object.

In the scene description information, at least one of a basic temperature or basic surface roughness of the scene may be stored as the sensory representation metadata in the extension area of the node corresponding to the scene.

In the scene description information, at least one of a basic temperature or basic surface roughness of the three-dimensional video object may be stored as the sensory representation metadata in the extension area of the node corresponding to the three-dimensional video object.

In the scene description information, at least one of link information to the temperature texture for representing the temperature or link information to the surface roughness texture for representing the surface roughness may be stored as the sensory representation metadata in the extension area of the node corresponding to the surface state of the three-dimensional video object.

A generation method executed by a computer system includes generating three-dimensional spatial data that is used in rendering processing executed to represent a three-dimensional space and that includes sensory representation metadata for representing at least one of a temperature or surface roughness with respect to a component of a scene configured by the three-dimensional space.

A reproduction apparatus according to an embodiment of the present technology includes a rendering section and a representation processing section.

The rendering section generates two-dimensional video data in which a three-dimensional space is represented corresponding to a field of view of a user by executing rendering processing on the three-dimensional spatial data on the basis of field of view information about the field of view of the user.

The representation processing section represents at least one of a temperature or surface roughness with respect to a component of a scene configured by the three-dimensional space on the basis of the three-dimensional spatial data.

In the generation apparatus, at least one of the temperature or the surface roughness is represented with respect to the component of the scene configured by the three-dimensional space on the basis of the three-dimensional spatial data. This makes it possible to realize the high-quality virtual video.

The representation processing section may represent at least one of the temperature or the surface roughness on the basis of sensory representation metadata included in the three-dimensional spatial data for representing at least one of the temperature or the surface roughness with respect to the component of the scene configured by the three-dimensional space.

The representation processing section may control a tactile presentation device used by the user such that at least one of the temperature or the surface roughness of the component is represented.

The representation processing section may generate a representation image in which at least one of the temperature or the surface roughness of the component is visually represented, and control the rendering processing by the rendering section to include the representation image.

The representation processing section may set a target area in which at least one of the temperature or the surface roughness is represented for the component on the basis of an input from the user, and control the rendering processing such that the target area is displayed by the representation image.

A reproduction method according to an embodiment of the present technology is a reproduction method executed by a computer system, and includes generating two-dimensional video data in which a three-dimensional space is represented corresponding to a field of view of a user by executing rendering processing on three-dimensional spatial data on the basis of field of view information about the field of view of the user.

On the basis of the three-dimensional spatial data, at least one of a temperature or surface roughness is represented with respect to a component of a scene configured by the three-dimensional space.

### BRIEF DESCRIPTION OF DRAWINGS

FIG. 1 A schematic diagram showing a basic configuration example of a virtual space provision system.

FIG. 2 A schematic diagram explaining rendering processing.

FIG. 3 A schematic diagram showing an example of a rendering video in which a three-dimensional space is represented.

FIGS. 4 Schematic diagrams showing an example of a wearable controller.

FIG. 5 A schematic diagram showing a configuration example of a broadcasting server and a client apparatus to realize representation of a temperature and surface roughness of a component according to the present technology.

FIG. 6 A schematic diagram showing an example of information described in a scene description file used as scene description information and video object data.

FIGS. 7 Schematic diagrams explaining an example of generating a temperature texture map.

FIG. 8 Schematic diagrams explaining an example of generating a surface roughness texture map.

FIGS. 9 Schematic diagrams explaining an example of surface roughness representation using the surface roughness texture map.

FIG. 10 A flowchart showing an example of content generation processing for presentation of a sense of tactile (presentation of temperature and surface roughness) by a generation section of a broadcasting server.

FIG. 11 A schematic diagram showing an example of storing tactile-related information and link information to a texture map for tactile representation.

FIG. 12 A schematic diagram showing an example of a description in glTF if an extras field specified in the glTF is used as a method of assigning a basic temperature and basic surface roughness of a scene to a “scene” hierarchy node.

FIG. 13 A schematic diagram showing an example of a description in the glTF if an extensions area specified in the glTF is used as the method of assigning the basic temperature and the basic surface roughness of the scene to the “scene” hierarchy node.

FIG. 14 A schematic diagram showing an example of a description in the glTF if the extras field specified in the glTF is used as the method of assigning the basic temperature and the basic surface roughness of a video object to a node in a “node” hierarchy.

FIG. 15 A schematic diagram showing an example of a description in the glTF if the extensions area specified in the glTF is used as the method of assigning the basic temperature and the basic surface roughness of the video object to the node in the “node” hierarchy.

FIG. 16 A schematic diagram showing an example of a description in the glTF if the extras field specified in the glTF is used as a method of assigning link information to the texture map for the tactile representation to a node in a “material” hierarchy.

FIG. 17 A schematic diagram showing an example of a description in the glTF if the extensions area specified in the glTF is used as the method of assigning the link information to the texture map for the tactile representation to the node in the “material” hierarchy.

FIG. 18 A table summarizing attribute information about representation of a temperature and surface roughness of a component of a scene.

FIG. 19 A flowchart showing an example of representation processing of a temperature and surface roughness by a representation processing section of a client apparatus.

FIG. 20 A schematic diagram explaining an example of an alternative presentation mode via a sense other than a sense of tactile.

FIGS. 21 Schematic diagrams explaining an example of an alternative presentation mode via the sense other than the sense of tactile.

FIG. 22 A bock diagram showing an example of a hardware configuration of a computer (information processing apparatus) that can realize a broadcasting server and the client apparatus.

### MODE(S) FOR CARRYING OUT THE INVENTION

Hereinafter, embodiments of the present technology will be described with reference to the drawings.

### [Virtual Space Provision System]

A virtual space provision system according to an embodiment of the present technology will be described first with a basic configuration example and a basic operation example.

The virtual space provision system according to this embodiment can provide free viewpoint three-dimensional virtual space content in which an imaginary three-dimensional space (three-dimensional virtual space) can be viewed from free viewpoint (6 degrees of freedom). Such three-dimensional virtual space content is also called 6DoF content.

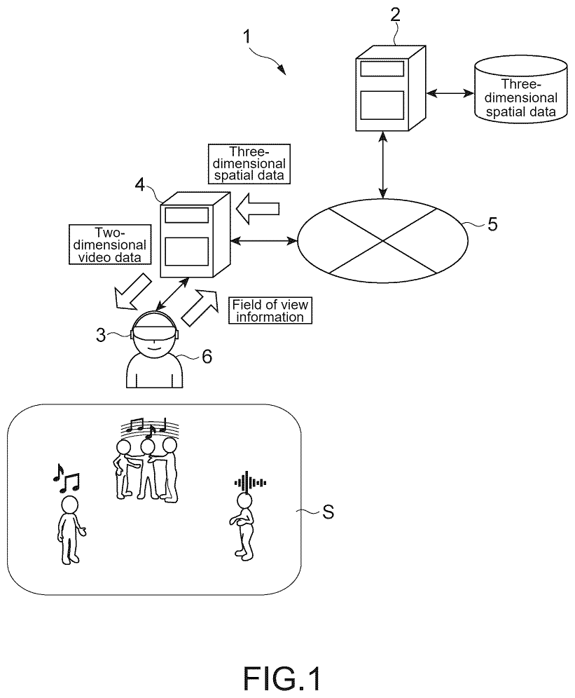

FIG. 1 is a schematic diagram showing a basic configuration example of the virtual space provision system.

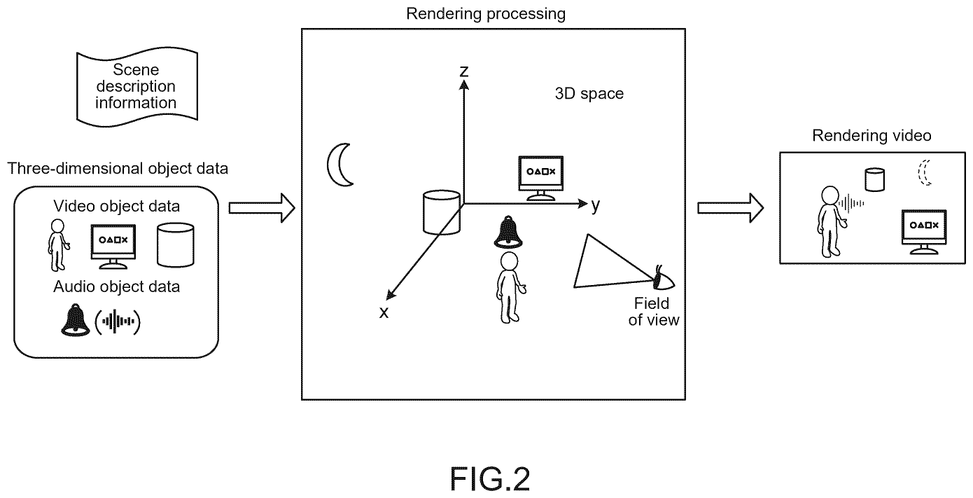

FIG. 2 is a schematic diagram explaining rendering processing.

A virtual space provision system 1 shown in FIG. 1 corresponds to an embodiment of an information processing system according to the present technology. A virtual space S shown in FIG. 1 corresponds to an embodiment of the imaginary three-dimensional space according to the present technology.

As shown in FIG. 1, the virtual space provision system 1 includes a broadcasting server 2, an HMD (Head Mounted Display) 3, and a client apparatus 4.

The broadcasting server 2 and the client apparatus 4 are communicatively connected via a network 5. The network 5 is constructed, for example, by the Internet or a wide-area telecommunications network. Any WAN (Wide Area Network), LAN (Local Area Network), and the like may also be used, and a protocol for constructing the network 5 is not limited.

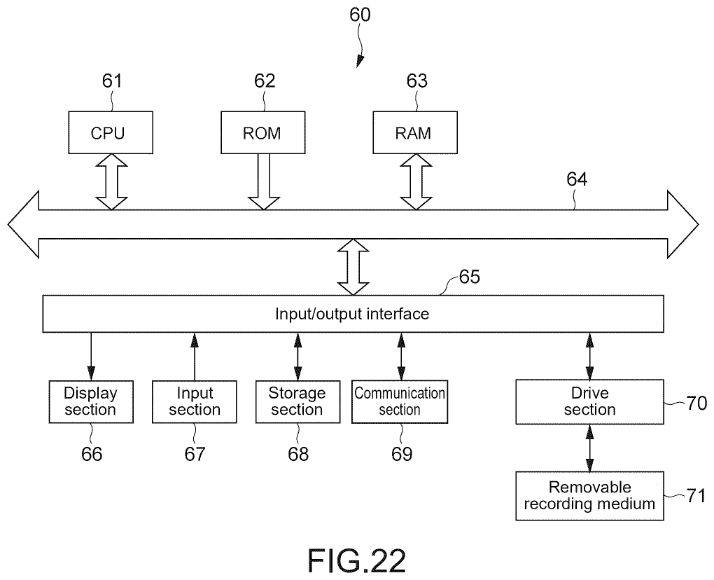

The broadcasting server 2 and the client apparatus 4 have hardware necessary for a computer, for example, for example, a processor such as a CPU, a GPU, or a DSP, a memory such as a ROM and a RAM, and a storage device such as an HDD (see FIG. 22). The information processing method (generation method and reproduction method) according to the present technology is executed when a processor loads a program according to the present technology stored in a storage section or a memory into the RAM and executes it.

For example, any computer, such as a PC (Personal Computer), can be used to realize the broadcasting server 2 and the client apparatus 4. It should be appreciated that the hardware such as an FPGA, an ASIC, and the like may also be used.

The HMD 3 and the client apparatus 4 are communicatively connected to each other. A form of communication for communicatively connecting both devices is not limited and any communication technology may be used. For example, wireless network communication such as WiFi or short-range wireless communication such as Bluetooth (registered trademark) can be used. The HMD 3 and the client apparatus 4 may be integrally configured. That is, the HMD 3 may include functions of the client apparatus 4.

The broadcasting server 2 broadcasts three-dimensional spatial data to the client apparatus 4. The three-dimensional spatial data is used in the rendering processing executed to represent the virtual space S (three-dimensional space). The rendering processing is executed on the three-dimensional spatial data to generate a virtual video that is displayed by the HMD 3. In addition, a virtual sound is output from headphones of the HMD 3. The three-dimensional spatial data will be described in detail later. The broadcasting server 2 can also be called a content server.

The HMD 3 is a device used to display the virtual video of each scene configured of the three-dimensional space and to output the virtual sound to a user 6. The HMD 3 is used by wearing around a head of the user 6. For example, when the VR video is broadcasted as the virtual video, an immersive HMD 3 that is configured to cover a field of view of the user 6 is used. When an AR (Augmented Reality) video is broadcasted as the virtual video, AR glasses or the like are used as the HMD 3.

A device other than the HMD 3 may be used to provide the virtual video to the user 6. For example, the virtual video may be displayed by a display provided on a TV, a smartphone, a tablet terminal, and a PC. A device capable of outputting the virtual sound is also not limited, and any form such as a speaker may be used.

In this embodiment, a 6DoF video is provided as the VR video to the user 6 wearing the immersive HMD 3. The user 6 will be able to view the video in the virtual space S including the three-dimensional space in a 360° range all around front/back, left/right, and up/down.

For example, the user 6 freely moves a position of a viewpoint, a direction of a line of sight in the virtual space S to change own field of view (field of view range). The virtual video displayed to the user 6 is switched in response to this change in the field of view of the user 6. By performing an action such as changing a direction of a face, tilting the face, or looking back, the user 6 can view surroundings in the virtual space S with a similar sense as in the real world.

Thus, the virtual space provision system 1 in this embodiment makes it possible to broadcast a photo-realistic free viewpoint video and to provide a viewing experience at a free viewpoint position.

In this embodiment, as shown in FIG. 1, the HMD 3 acquires field of view information. The field of view information is information about the field of view of the user 6. Specifically, the field of view information includes any information that can identify the field of view of the user 6 in the virtual space S.

For example, the field of view information includes a viewpoint position, a gaze point, a central field of view, the direction of the line of sight, and a rotation angle of the line of sight. Also, the field of view information includes a head position of the user 6, a head rotation angle of the user 6, and the like.

The rotation angle of the line of sight can be specified, for example, by a rotation angle with an axis extending in the direction of the line of sight as a rotation axis. The head rotation angle of the user 6 can be specified by a roll angle, a pitch angle, and a yaw angle when three mutually orthogonal axes set for the head are defined as a roll axis, a pitch axis, and a yaw axis.

For example, an axis extending in a frontal direction of the face is defined as the roll axis. An axis extending in a right and left direction when a face of the user 6 is viewed from the front is defined as the pitch axis, and an axis extending in an up and down direction is defined as the yaw axis. The roll angle, the pitch angle, and the yaw angle relative to the roll axis, the pitch axis, and the yaw axis are calculated as the rotation angle of the head. The direction of the roll axis can also be used as the direction of the line of sight.

Any other information that can identify the field of view of the user 6 may be used. As the field of view information, one of the information described above may be used, or a combination of plurality of pieces of information may be used.

A method of acquiring the field of view information is not limited. For example, it is possible to acquire the field of view information on the basis of a detection result (sensing result) by a sensor apparatus (including camera) provided in the HMD 3.

For example, the HMD 3 is provided with a camera or a distance measurement sensor that has a detection range around the user 6, an inward-facing camera that can capture an image of left and right eyes of the user 6, or the like. In addition, the HMD 3 is provided with an IMU (Inertial Measurement Unit) sensor and a GPS. For example, position information of the HMD 3 acquired by the GPS can be used as the viewpoint position of the user 6 and the head position of the user 6. It should be appreciated that the positions of the left and right eyes of the user 6, or the like may be calculated in more detail.

It is also possible to detect the direction of the line of sight from the captured image of the left and right eyes of the user 6. It is also possible to detect the rotation angle of the line of sight and the head rotation angle of the user 6 from an IMU detection result.

A self-position estimation of the user 6 (HMD 3) may be executed on the basis of the detection result by the sensor apparatus provided in the HMD 3. For example, it is possible to calculate the position information of the HMD 3 and posture information such as which direction the HMD 3 is facing by the self-position estimation. From the position information and the posture information, it is possible to acquire the field of view information.

An algorithm for estimating the self-position of the HMD 3 is not limited, and any algorithm such as an SLAM (Simultaneous Localization and Mapping) may be used. Head tracking to detect a head movement of the user 6 and eye tracking to detect a movement of left and right line of sight (movement of gaze point) of the user 6 may also be executed.

In addition, any device or any algorithm may be used to acquire the field of view information. For example, when a smartphone or the like is used to display the virtual video to the user 6, an image of the face (head), or the like of the user 6 may be captured and the field of view information may be acquired on the basis of the captured image.

Alternatively, a device equipped with the camera, the IMU, or the like may be worn around the head and eyes of the user 6.

Any machine learning algorithm using, for example, a DNN (Deep Neural Network) may be used to generate the field of view information. For example, an AI (Artificial Intelligence) that performs Deep Learning (deep learning) may be used to improve the accuracy of generating the field of view information. A machine learning algorithm may be applied to any processing in the present disclosure.

The client apparatus 4 receives the three-dimensional spatial data transmitted from the broadcasting server 2 and the field of view information transmitted from the HMD 3. The client apparatus 4 executes the rendering processing on the three-dimensional spatial data on the basis of the field of view information. This generates two-dimensional video data (rendering video) corresponding to the field of view of the user 6.

As shown in FIG. 2, the three-dimensional spatial data includes scene description information and three-dimensional object data. The scene description information is also called scene description (Scene Description).

The scene description information is information that defines a configuration of the three-dimensional space (virtual space S) and can be called three-dimensional space description data. The scene description information also includes various metadata to reproduce each scene of the 6DoF content.

A specific data structure (data format) of the scene description information is not limited and any data structure may be used. For example, a glTF (GL Transmission Format) can be used as the scene description information.

The three-dimensional object data is data that defines a three-dimensional object in the three-dimensional space. That is, it is data of each object that configures each scene of the 6DoF content. In this embodiment, video object data and audio (sound) object data are broadcasted as the three-dimensional object data.

The video object data is data that defines a three-dimensional video object in the three-dimensional space. The three-dimensional video object is configured of geometry information that represents a shape of an object and color information of a surface of the object. For example, geometry data including a set of many triangles called a polygon mesh or a mesh defines the shape of the surface of the three-dimensional video object. Texture data is attached to each triangle to define its color, and the three-dimensional video object is defined in the virtual space S.

Another data format that configures the three-dimensional video object is Point Cloud (point cloud) data. The point cloud data includes position information for each point and color information for each point. By placing the point with a predetermined color information at a predetermined position, the three-dimensional video object is defined in the virtual space S. The geometry data (position of mesh and point cloud) is represented in a local coordinate system specific to the object. An object placement in the three-dimensional virtual space is specified by the scene description information.

The video object data includes, for example, data of the three-dimensional video object such as a person, an animal, a building, a tree, and the like. Alternatively, it includes data of the three-dimensional video object such as a sky and a sea that configure a background, and the like. A plurality of types of objects may be grouped together to form a single three-dimensional video object.

The audio object data is configured of position information of a sound source and waveform data from which sound data for each sound source is sampled. The position information of the sound source is a position in the local coordinate system on which the three-dimensional audio object group is based, and the object placement on the three-dimensional virtual space group S is specified by the scene description information.

As shown in FIG. 2, the client apparatus 4 reproduces the three-dimensional space by placing the three-dimensional video object and the three-dimensional audio object in the three-dimensional space on the basis of the scene description information. Then, with reference to the reproduced three-dimensional space, the video as seen from the user 6 is cut out (rendering processing) to generate a rendering video, which is a two-dimensional video viewed by the user 6. It is noted that the rendering video corresponding to the field of view of the user 6 can also be said to be a video of a viewport (display area) that corresponds to the field of view of the user 6.

The client apparatus 4 also controls the headphones of the HMD 3 so that the sound represented by the waveform data is output using the position of the three-dimensional audio object as a sound source position through the rendering processing. That is, the client apparatus 4 generates sound information to be output from the headphones and output control information to specify how the sound information is output.

The sound information is generated, for example, on the basis of the waveform data contained in a three-dimensional audio object. As the output control information, any information that defines the volume, sound localization (localization direction), and the like may be generated. For example, by controlling the sound localization, it is possible to realize a sound output with a stereophonic sound.

The rendering video, the sound information, and the output control information generated by the client apparatus 4 are transmitted to the HMD 3. The HMD 3 displays the rendering video and outputs the sound information. This enables the user 6 to view the 6Dof content.

Hereinafter, the three-dimensional video object may be described simply as a video object. Similarly, the three-dimensional audio object may be described simply as an audio object.

### [Representation of Temperature and Surface Roughness in Virtual Space S]

Technological development is underway to construct a three-dimensional virtual space on a computer that is so realistic that it is indistinguishable from a real space. Such a three-dimensional virtual space is also called a digital twin or metaverse, for example.

In order to present the three-dimensional virtual space S more realistically, it is considered important to be able to represent senses other than a sense of sight and a sense of hearing, for example, a sense of tactile, which is a sense when touching the video object. For example, the virtual space S can be regarded as a kind of content designed and constructed by a content creator. The content creator sets the individual surface state for each video object existing in the virtual space S. This information is transmitted to the client apparatus 4 and presented (reproduced) to the user. In order to realize such a system, the inventor has studied repeatedly.

As a result, the present inventor has devised a new data format for representing a temperature and surface roughness set by the content creator with respect to the component configuring the scene in the virtual space S, which can be broadcasted from the broadcasting server 2 to the client apparatus 4. As a result, it is now possible for the user to reproduce the temperature and the surface roughness of each component as intended by the content creator.

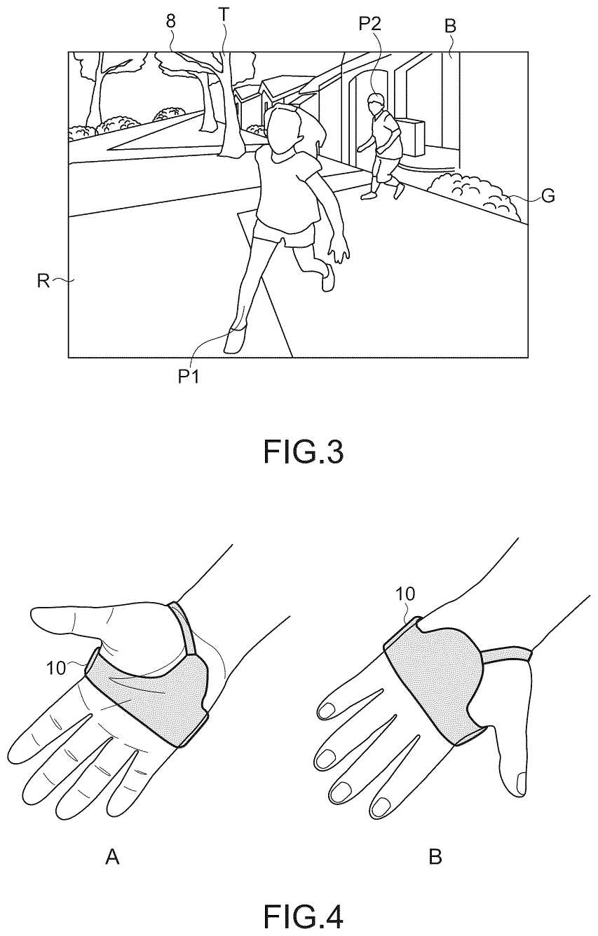

FIG. 3 is a schematic diagram showing an example of a rendering video 8 in which the three-dimensional space (virtual space S) is represented. The rendering video 8 shown in FIG. 3 is the virtual video displaying a “chase” scene, which displays each video object of a person running away (person P1), a person chasing (person P2), a tree T, grass G, a building B, and a ground R.

The person P1, the person P2, the tree T, the grass G, and the building B are the video objects with geometry information, which forms an embodiment of the component of the scene according to the present technology. In addition, according to the present technology, the component with no geometry information is also included in the embodiment of the component of the scene according to the present technology. For example, air (atmosphere), the ground R, or the like in the space where the “chase” is taking place is the component with no geometry information.

By applying the present technology, it is possible to add temperature information to each component of the scene. That is, it is possible to present a surface temperature of each of the person P1, the person P2, the tree T, the grass G, the building B, and the ground R to the user 6. It is also possible to present a temperature of a surrounding environment, i.e., air temperature to the user.

By applying the present technology, it is possible to add surface roughness information to each component of the scene. That is, it is possible to present the surface roughness of the person P1, the person P2, the tree T, the grass G, the building B, and the ground R to the user 6. The surface roughness is a minute irregularity that is not represented in the geometry information (plurality of pieces of mesh data or point clouds) that defines the shape of the video object.

In the following description, the temperature and the surface roughness relating to the component of the scene may be described on behalf of the surface state of the video object. For example, in explaining a data format and a broadcasting method that enable the representation of the temperature and the surface roughness relating to the component of the scene, descriptions such as the data format and the broadcasting method that enable the representation of the surface state of the video object may be used. It should be appreciated that content of such description also applies to the temperature and the surface roughness of the component of the scene other than the surface state of the video object, such as the temperature of the surrounding environment.

For a human, the temperature and the surface roughness are recognized (perceived) by a sense of skin. That is, the temperature is perceived by stimulation of a sense of warmth and a sense of coldness, and the surface roughness is perceived by stimulation of the sense of tactile. In the following explanation, a presentation of the temperature and the surface roughness may be collectively referred to as a presentation of the sense of tactile. That is, the sense of tactile may be described in the same broad sense as the sense of skin.

FIG. 4 are schematic diagrams showing an example of a wearable controller.

A of FIG. 4 is a schematic diagram showing an appearance of the wearable controller at a palm side of a hand.

B of FIG. 4 is a schematic diagram showing the appearance of the wearable controller at a back side of the hand.

A wearable controller 10 is configured as a so-called palm vest type device and is used by wearing on the hand of the user 6.

The wearable controller 10 is communicatively connected to the client apparatus 4. The form of communication for communicatively connecting both devices is not limited, and any communication technology may be used, including the wireless network communication such as the WiFi or the short-range wireless communication such as the Bluetooth (registered trademark).

Although not shown in the figure, various devices such as a camera, a 9-axis sensor, the GPS, the distance measurement sensor, a microphone, an IR sensor, and an optical marker are mounted at a predetermined position on the wearable controller 10.

For example, the cameras are placed on the palm side and the back side of the hand, respectively, so that the fingers can be photographed. On the basis of images of the fingers photographed by the cameras, the detection result of each sensor (sensor information), and the sensing result of IR light reflected by the optical marker, it is possible to execute recognition processing of the hand of the user 6.

Therefore, it is possible to acquire various types of information such as a position, a posture, and a movement of the hand or each finger. It is also possible to execute determination of an input operation such as a touch operation and a gesture using the hand. The user 6 can perform various gesture inputs and operations on the virtual object using own hand.

Although not shown in the figure, a temperature adjustment element capable of maintaining an indicated temperature is mounted at the predetermined position on the wearable controller 10 as a tactile presentation part (presentation part of sense of skin). The temperature adjustment element is driven to enable the hand of the user 6 to experience various temperatures. The specific configuration of the temperature adjustment element is not limited, and any device such as a heating element (electric heating wire) or a Peltier element may be used.

In addition, a plurality of vibrators are mounted at the predetermined position on the wearable controller 10, also as the tactile presentation part. By driving the vibrators, various patterns of the sense of tactile (sense of pressure) can be presented to the hand of the user 6. The specific configuration of the vibrators is not limited, and any configuration may be adopted. For example, vibration may be generated by an eccentric motor, an ultrasonic vibrator, or the like. Alternatively, the sense of tactile may be presented by controlling a device with many fine protrusions densely arranged.

Other arbitrary configurations and arbitrary methods may be adopted to acquire movement information and the sound information of the user 6. For example, the camera, the distance measurement sensor, the microphone, and the like may be placed around the user 6, and on the basis of the detection result, the movement information and the sound information of the user 6 may be acquired. Alternatively, various forms of wearable devices on which a motion sensor is mounted may be worn by the user 6, and the movement information or the like of the user 6 may be acquired on the basis of a detection result of the motion sensor.

The tactile presentation device (also called presentation device of sense of skin) capable of presenting the temperature and the surface roughness to the user 6 are not limited to the wearable controller 10 shown in FIG. 4. For example, the various forms of the wearable devices such as a wristband type worn on a wrist, an arm ring type worn on an upper arm, a headband type (head mounted type) worn on a head, a neckband type worn on a neck, a body type worn on a chest, a belt type worn on a waist, an anklet type worn on an ankle, and the like may be adopted. These wearable devices make it possible to experience the temperature and the surface roughness at various body parts of the user 6.

It should be appreciated that it is not limited to the wearable devices that can be worn by the user 6. The tactile presentation part may be configured in an area held by the user 6, such as a controller.

In the virtual space presentation system 1 shown in FIG. 1, the broadcasting server 2 is constructed as an embodiment of the generation apparatus according to the present technology to execute the generation method according to the present technology. Also, the client apparatus 4 is configured as an embodiment of the reproduction apparatus according to the present technology to execute the reproduction method according to the present technology. This makes it possible to present the surface state of the video object (temperature and surface roughness of component of scene) to the user 6.

For example, in the scene in the virtual space S shown in FIG. 3, the user 6 holds a hand with the person P1 or touches the tree T or the building B with the hand wearing the wearable controller 10. In this way, the user can experience the temperature of the hand of the person P1 and the temperature of the tree T or the building B. It is also possible to perceive a fine shape (fine irregularity) of the palm of the person P1 and roughness of the tree T or the building B.

Air temperature can also be perceived via the wearable controller 10. For example, if it is a summer scene, a relatively hot temperature is perceived via the wearable controller 10. If it is a winter scene, a relatively cold temperature is perceived via the wearable controller 10.

This makes it possible to present a highly realistic virtual space S and realize a high-quality virtual video. Hereinafter, it will be described in detail.

### [Generation of Three-Dimensional Spatial Data]

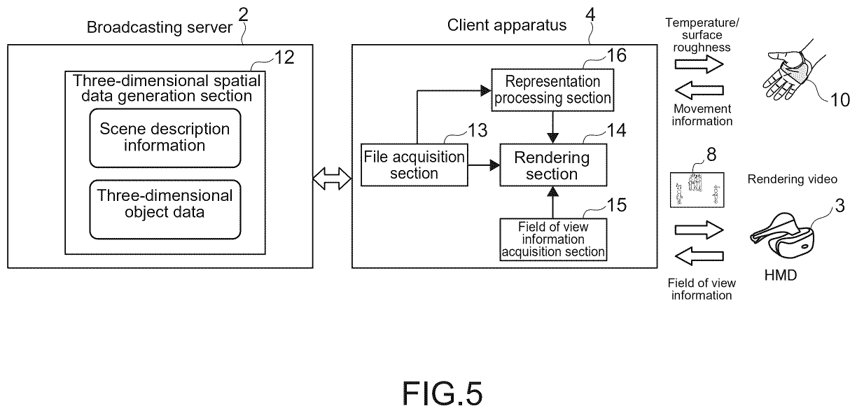

FIG. 5 is a schematic diagram showing a configuration example of the broadcasting server 2 and the client apparatus 4 to realize representation of the temperature and the surface roughness of the component according to the present technology.

As shown in FIG. 5, the broadcasting server 2 has a three-dimensional spatial data generation section (hereinafter simply referred to as “generation section”) 12. The client apparatus 4 has a file acquisition section 13, a rendering section 14, a field of view information acquisition section 15, and a representation processing section 16.

In each of the broadcasting server 2 and the client apparatus 4, each of the functional blocks shown in FIG. 5 is realized by a processor, for example, the CPU, executing a program according to the present technology, and the information processing method (generation method and reproduction method) according to this embodiment is executed. Dedicated hardware such as an IC (integrated circuit) may be used as appropriate to realize each functional block.

First, the generation of the three-dimensional spatial data by the broadcasting server 2 will be described. In this embodiment, the generation section 12 of the broadcasting server 2 generates the three-dimensional spatial data including sensory representation metadata for representing at least one of the temperature or the surface roughness with respect to the component of the scene configured by the virtual space S. The generation section 12 is an embodiment of the generation section according to the present technology.

As shown in FIG. 5, the three-dimensional spatial data includes the scene description information that defines the configuration of the virtual space S and the three-dimensional object data that defines the three-dimensional object in the virtual space S. The generation section 12 generates at least one of the scene description information including the sensory representation metadata or the three-dimensional object data including the sensory representation metadata. As the three-dimensional object data including the sensory representation metadata, the video object data including the sensory representation metadata is generated.

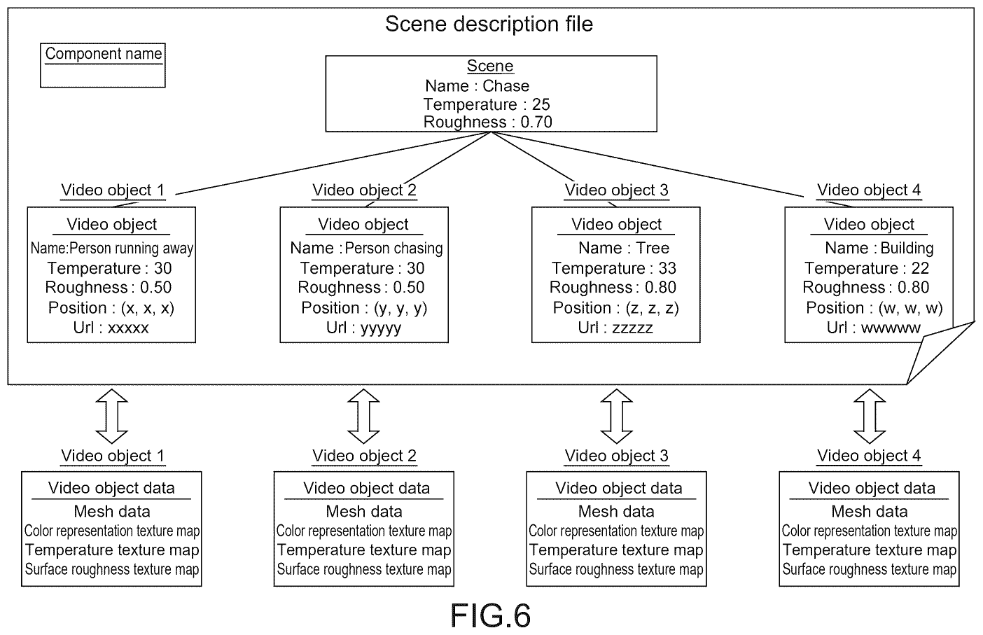

FIG. 6 is a schematic diagram showing an example of information described in a scene description file used as the scene description information, and the video object data.

In the example shown in FIG. 6, the following information is stored as scene information described in the scene description file.
Name . . . name of the scene
Temperature . . . basic temperature of the scene
Roughness . . . basic surface roughness of the scene

Thus, in this embodiment, fields describing “Temperature” and “Roughness” as the sensory representation metadata are newly defined in scene element attributes of the scene description file.

The basic temperature of the scene, described as “Temperature,” is data that defines the temperature of an entire scene and typically corresponds to the temperature (air temperature) of the surrounding environment.

Both absolute and relative temperature representations can be used to represent the temperature. For example, a predetermined temperature may be described as “the basic temperature of the scene” regardless of the temperature of the video object present in the scene. On the other hand, a value relative to a predetermined reference temperature may be described as “the basic temperature of the scene”.

A unit of the temperature is also not limited. For example, any unit may be used, such as Celsius (° C.), Fahrenheit (° F.), absolute temperature (K), and the like

The basic surface roughness of the scene, described as “Roughness,” is data that defines the surface roughness of the entire scene. In this embodiment, a roughness coefficient from 0.00 to 1.00 is described. The roughness coefficient is used to generate a height map (irregularity information) described later, with the roughness coefficient=1.00 being the strongest roughness state and the roughness coefficient=0.00 being the weakest roughness state (including zero).

In the example shown in FIG. 6, the following information is stored as video object information described in the scene description file.
Name . . . object name
Temperature . . . basic temperature of video object
Roughness . . . basic surface roughness of video object
Position . . . position of video object
Url . . . address of three-dimensional object data

Thus, in this embodiment, fields describing “Temperature” and “Roughness” as the sensory representation metadata are newly defined in the attributes of the video object element of the scene description file.

The basic temperature of the video object described as “Temperature” is data that defines the overall temperature of each video object. It is possible to describe the basic temperature for each video object in the scene.

As the basic temperature of the video object, an absolute temperature representation that is independent of the temperature of the surrounding environment or the temperature of other video objects being in contact may be adopted. Alternatively, a temperature representation on the basis of a relative value to the surrounding environment or the reference temperature may be adopted. The unit of the temperature is also not limited. Typically, the same unit as the overall scene temperature is used.

The basic surface roughness of the video object, described as “Roughness,” is data that defines the surface roughness of the entire of each video object. It is possible to set the basic surface roughness for each video object in the scene. In this embodiment, the roughness coefficient from 0.00 to 1.00 is described as well as the basic surface roughness of the scene.

The Url shown in FIG. 6 is link information to the video object data corresponding to each video object. In the example shown in FIG. 6, as the video object data, mesh data and a color representation texture map that is attached to the surface are generated. Furthermore, in this embodiment, a temperature texture map for representing the temperature and a surface roughness texture map for representing the surface roughness are generated as the sensory representation metadata.

The temperature texture map is a texture map for specifying a temperature distribution on the surface of each video object. The surface roughness texture map is a texture map that defines the roughness distribution (irregularity distribution) of the surface of each video object. By generating these texture maps, it is possible to set a temperature distribution and a surface roughness distribution in a microscopic unit for the surface of the video object.

The temperature texture map is an embodiment of the temperature texture according to the present technology and can be referred to as temperature texture data. The surface roughness texture map is an embodiment of the surface roughness texture according to the present technology, and can also be referred to as surface roughness texture data.

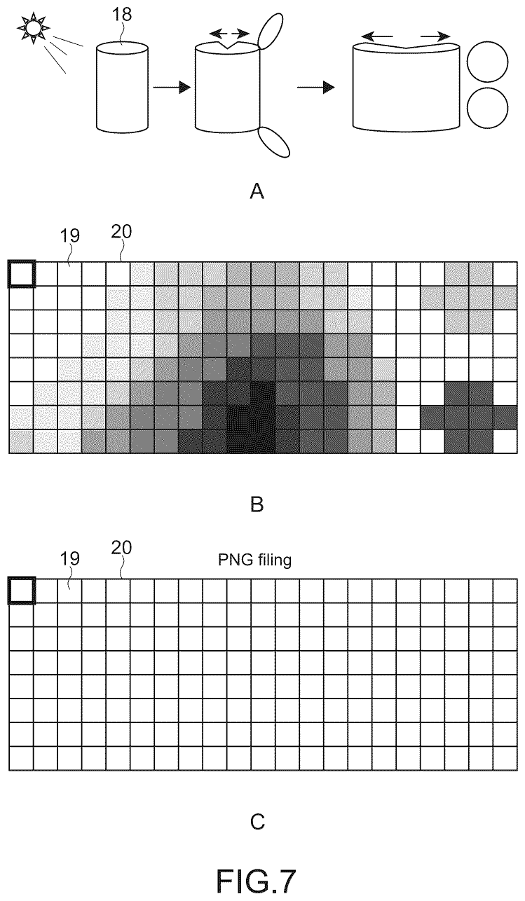

FIG. 7 are schematic diagrams showing an example of generating the temperature texture map.

As shown in A of FIG. 7, a surface of a video object 18 is exploded into a two-dimensional plane. As shown in B of FIG. 7, the surface of the video object 18 is exploded into microscopic compartments (texels) 19, and the temperature information is assigned to each texel to be capable of generating a temperature texture map 20.

In this embodiment, a signed floating point value with a 16-bit length is set as the temperature information for one texel. The temperature texture map 20 is then filed as PNG data (image data) with the 16-bit length per pixel. Although the data format of the PNG file is an integer of 16 bits, the temperature data is processed as a signed floating point with the 16-bit length. This makes it possible to represent a high-precision temperature value with a decimal point or a negative temperature value.

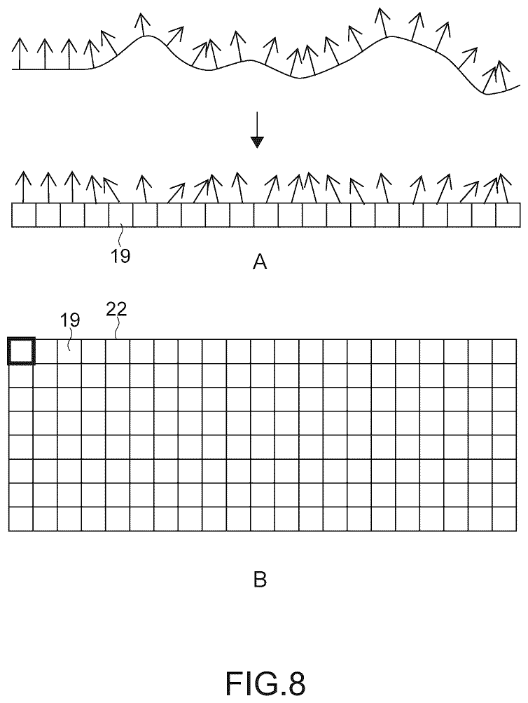

FIG. 8 are schematic diagrams showing an example of generating the surface roughness texture map.

In this embodiment, a surface roughness texture map 22 is generated by setting normal vector information for each texel 19. The normal vector can be specified by a three-dimensional parameter that represents a direction of a vector in a three-dimensional space.

For example, as schematically shown in A of FIG. 8, the normal vector corresponding to the surface roughness (fine irregularity) to be designed is set for each texel 19 for the surface of the video object 18. As shown in B of FIG. 8, the surface roughness texture map 22 is generated by exploding a distribution of the normal vector set for each texel 19 into a two-dimensional plane.

The data format of the surface roughness texture map 22 can be the same format as the normal texture map, for example, for visual representation. Alternatively, xyz information is arranged in a predetermined sequence of integers and can be filed as the PNG data (image data).

Specific configuration, generation method, data format and filing, and the like of the temperature texture map 20 that defines the temperature distribution on the surface of the video object 18 are not limited, and the temperature texture map 20 may be configured in any form.

Similarly for the surface roughness texture map 22, specific configuration, generation method, data format and filing, and the like are not limited, and the surface roughness texture map 22 may be configured in any form.

If the normal texture map for the visual representation is prepared, the surface roughness texture map 22 may be generated on the basis of the normal texture map for the visual representation. The normal texture map for the visual representation is information used to make it appears as if there is the irregularity by utilizing visual illusions caused by light shading. Therefore, it is not reflected in a geometry of the video object during the rendering processing.

By not reflecting the minute irregularity visually represented by the normal texture map in the geometry during the rendering, problems such as an increase in a data volume of the geometry data configuring the video object and an increase in a processing load of the rendering processing are suppressed.

On the other hand, suppose that user 6 is wearing a haptics device (tactile presentation device) that allows to feel its shape (geometry) by touching the video object in the three-dimensional virtual space S. Then, even if the user touches the video object, the user cannot feel tactilely the irregularity corresponding to an irregularity part visually represented by the normal texture map.

In this embodiment, it is possible to generate the surface roughness texture map using the normal texture map for the visual representation. For example, the normal texture map for visual presentation can be converted directly into the surface roughness texture map. In this case, it can be said that the normal texture map for the visual representation is converted into the normal texture map for tactile presentation.

By converting the normal texture map for the visual representation as the surface roughness texture map 22, it is possible to present the sense of tactile corresponding to a visual irregularity to the user 6. As a result, it is possible to realize a highly accurate virtual video. In addition, by converting the normal texture map for the visual representation, it is possible to reduce a burden on the content creator. It should be appreciated that the surface roughness texture map 22 may be generated by adjusting or processing the normal texture map for the visual representation.

In FIGS. 7 and 8, the temperature information and the normal vector are set for each texel. It is not limited thereto, the temperature information and the normal vector may be set for each mesh that defines the shape of the video object 18.

If a point cloud is used as the geometry information, for example, the temperature information and the normal vector can be set for each point. Alternatively, the temperature information and the normal vector may be set for each area enclosed by adjacent points. For example, by equating a vertex of a triangle in the mesh data with each point in the point cloud, the same processing can be performed for the point cloud as for the mesh data.

As the irregularity information set as the surface roughness texture map, data different from the normal vector may be set. For example, the height map with height information set for each texel or mesh may be generated as the surface roughness texture map.

Thus, in this embodiment, as the video object data corresponding to each video object, the temperature texture map 20 and the surface roughness texture map 22 are generated as the sensory representation metadata.

The “Url,” which is described as the video object information in the scene description file shown in FIG. 6, can be said to be the link information to the temperature texture map and the surface roughness texture map. That is, in this embodiment, the link information to the texture map is described as the sensory representation metadata in the attributes of the video object element of the scene description file.

It should be appreciated that the scene description file may contain the link information for each of the mesh data, the color representation texture map, the temperature texture map, and the surface roughness texture map. If the normal texture map for the visual presentation is prepared and is converted into the surface roughness texture map, the link information to the normal texture map for the visual presentation may be described as the link information to the surface roughness texture map (normal texture map for tactile presentation).

Returning to FIG. 5, a configuration example of the client apparatus 4 is described.

The file acquisition section 13 acquires the three-dimensional spatial data (scene description information and three-dimensional object data) broadcasted from the broadcasting server 2. The field of view information acquisition section 15 acquires the field of view information from the HMD 3. The acquired field of view information may be recorded in a storage section 68 (see FIG. 22) or the like. For example, a buffer or the like may be configured to record the field of view information.

The rendering section 14 executes the rendering processing shown in FIG. 2. That is, the rendering section 14 executes the rendering processing on the three-dimensional spatial data on the basis of the line of sight information of the user 6 to generate the two-dimensional video data (rendering video 8) in which the three-dimensional space (virtual space S) is represented corresponding to the field of view of the user 6.

By executing the rendering processing, the virtual sound is output with the position of the audio object as the sound source position.

The representation processing section 16 represents at least one of the temperature or the surface roughness with respect to the component of the scene configured by the three-dimensional space (virtual space S) on the basis of the three-dimensional spatial data. In this embodiment, the three-dimensional spatial data including the sensory representation metadata that represents the temperature and the surface roughness of the component of the scene is generated by the generation section 12 of the broadcasting server 2. The representation processing section 16 reproduces the temperature or the surface roughness for the user 6 on the basis of the sensory representation metadata included in the three-dimensional spatial data.

As shown in FIG. 6, in this embodiment, the movement information of the user 6 is transmitted by the wearable controller 10. On the basis of the movement information, the representation processing section 16 determines the movement of the hand of the user 6, a collision or a contact with the video object, a gesture input, or the like. Then, the processing to represent the temperature or the surface roughness is executed according to the contact of the user 6 with the video object, the gesture input, or the like. The determination of the gesture input and the like may be executed on a wearable controller 10 side and a determination result may be transmitted to the client apparatus 4.

For example, if the hand does not touch anywhere in the scene in the virtual space S shown in FIG. 3, the temperature adjustment element of the wearable controller 10 is controlled on the basis of the basic temperature of the scene. If the user 6 touches the video object, the temperature adjustment element of the wearable controller 10 is controlled on the basis of the basic temperature of the video object, or the temperature texture map. This enables the user to experience the air temperature, the warmth of the person, and the like, as if in the real space.

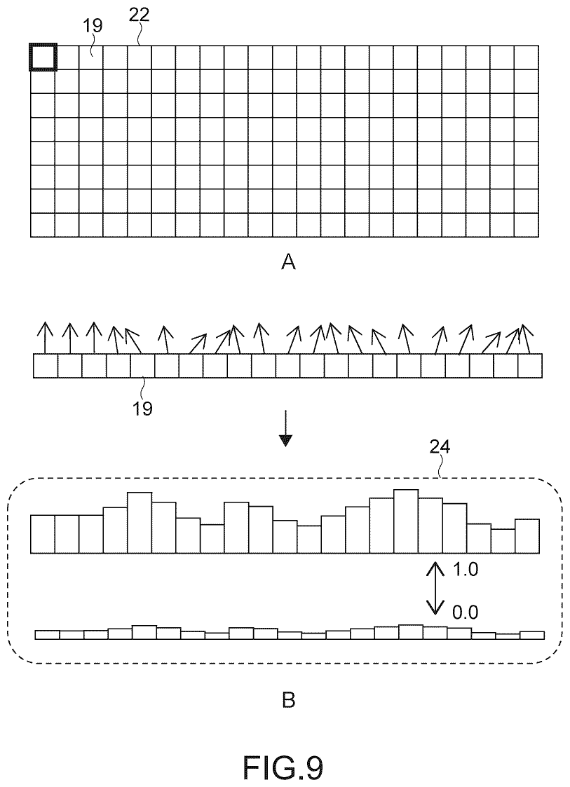

FIG. 9 are schematic diagrams showing an example of surface roughness representation (tactile presentation) using the surface roughness texture map.

As shown in A of FIG. 9, the representation processing section 16 extracts the surface roughness texture map 22 generated for each video object on the basis of the link information described in the scene description file.

As schematically shown in B of FIG. 9, in this embodiment, a height map 24 with height information set for each texel of the video object is generated on the basis of the surface roughness texture map 22. In this embodiment, the surface roughness texture map 22 with the normal vector set for each texel is generated. In this case, conversion into the height map is similar to the conversion from the normal texture map for the visual representation to the height map for the visual representation, but a parameter that determines a variation range of the irregularity or a degree of an intensity of an irregularity stimulus to the user 6, so to speak, a parameter that specifies a magnification factor of the relative irregularity representation by the normal vector is required.

As the parameter, the roughness coefficient (0.00 to 1.00) described in the scene description file as the basic surface roughness of the scene and the basic surface roughness of the video object is used. For the area where both the basic surface roughness of the scene and the basic surface roughness of the video object are set, the basic surface roughness of the video object is preferentially used.

As shown in B of FIG. 9, if the roughness coefficient is close to 0.00, the variation range of a surface irregularity is set to be small, and if the roughness coefficient is close to 1.00, the variation range of the surface irregularity is set to be large. By adjusting the roughness coefficient, it is possible to control the presentation of the sense of tactile to the user 6.

The vibrators of the wearable controller 10 are controlled by the representation processing section 16 on the basis of the generated height map for tactile presentation. This makes it possible for the user 6 to experience the minute irregularity that is not specified in the geometry information of the video object. For example, it is possible to present the sense of tactile that corresponds to the visual irregularity.

The height map 24 shown in FIG. 9 may be generated as the surface roughness texture map on a broadcasting server 2 side.

As shown in FIG. 6, in this embodiment, the basic temperature and the surface roughness of the scene are described in the scene description file as the scene information. As the video object information, the basic temperature of the video object and the basic surface roughness of the video object are described. As the video object information, the link information to the temperature texture map and the link information to the surface roughness texture map are also described. The temperature texture map and the surface roughness texture map are generated as the video object data.

Thus, the sensory representation metadata for representing the surface state (temperature and surface roughness) of the video object is stored in the scene description information and the video object data and broadcasted to the client apparatus 4 as the content.

The client apparatus 4 controls the tactile presentation part (temperature control mechanism and vibrators) of the wearable controller 10, which is the tactile presentation device, on the basis of the sensory representation metadata included in the three-dimensional spatial data. This makes it possible to reproduce the surface state (temperature and surface roughness) of the video object for the user 6.

For example, first, the temperature and the surface roughness of the entire three-dimensional virtual space S (temperature and basic surface roughness of scene) are set, and then the individual temperature and the individual surface roughness (temperature and basic surface roughness of video object) are determined for each video object configuring the scene. Furthermore, the temperature distribution and the surface roughness distribution within the video object are represented by the temperature texture map and the surface roughness texture map. This hierarchical setting of the temperature and the surface roughness is possible. By setting the temperature and the surface roughness of the entire scene using the temperature information and the surface roughness information with a wide range of applicability, and then overwriting them with the temperature information and the surface roughness information with a narrower range of applicability, it is possible to represent the detailed temperature and the detailed surface roughness of the individual components (parts) that make up the scene.

It should be appreciated that any of representation in a scene unit, representation in a video object unit, or representation by the texture map in a microscopic unit may be selected as appropriate. Only one of the temperature representation and the surface roughness representation may be adopted. The unit and the content of each scene may be selected in combination, as appropriate.

[Representation of Temperature and Surface Roughness in glTF Format]

A method of representing the temperature and the surface roughness will be described if the glTF is used as the scene description information.

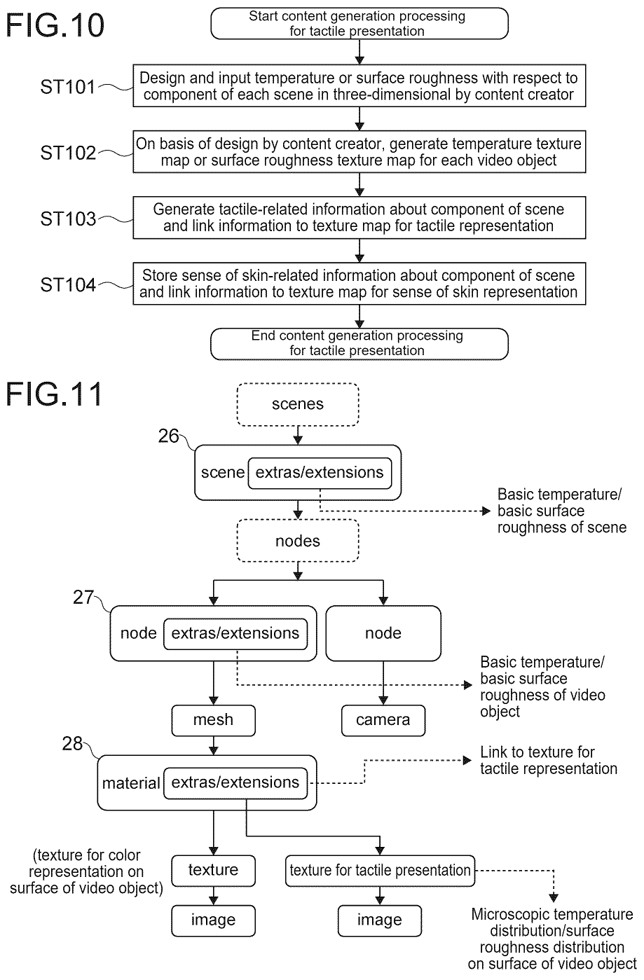

FIG. 10 is a flowchart showing an example of content generation processing for the tactile presentation (presentation of temperature and surface roughness) by the generation section 12 of the broadcasting server 2. The generation of the content for the tactile presentation corresponds to the generation of the three-dimensional spatial data including the sensory representation metadata that represents at least one of the temperature and the surface roughness.

The temperature or the surface roughness with respect to the component of each scene in the three-dimensional virtual space S is designed and input by the content creator (Step 101).

On the basis of the design by the content creator, the temperature texture map or the surface roughness texture map is generated for each video object that is the component of the scene (Step 102). The temperature texture map or the surface roughness texture map is data used as the sensory representation metadata, and is generated as the video object data.

Tactile-related information about the component of the scene and the link information to the texture map for the tactile representation are generated (Step 103). The tactile-related information is, for example, the sensory representation metadata such as the basic temperature of the scene, the basic surface roughness of the scene, the basic temperature of the video object, and the basic surface roughness of the video object.

The texture map for the tactile representation is the temperature texture map 20 and the surface roughness texture map 22. The link information to the temperature texture map 20 and the surface roughness texture map 22 stored in the scene description information are the link information to the texture map for the tactile representation. The tactile-related information can also be called sense of skin-related information. It is also possible to call the texture map for the tactile representation as a texture map for a sense of skin representation.

In an extension area of the glTF, the tactile-related information about the component of the scene and the link information to the texture map for the tactile representation are stored (Step 104). Thus, in this embodiment, the sensory representation metadata is stored in the extension area of the glTF.

FIG. 11 is a schematic diagram showing an example of storing the tactile-related information and the link information to the texture map for the tactile representation.

As shown in FIG. 11, in the glTF, a relationship between the parts (components) that make up the scene is represented by a tree structure including a plurality of nodes (joints). FIG. 11 represents a scene configured with the intention that a single video object exists in the scene and that the video in which the scene is seen from a viewpoint of a camera placed at a certain position can be obtained by rendering. The camera is also included in the component of the scene.

The position of the camera specified by the glTF is an initial position, and by updating the field of view information sent from the HMD 3 to the client apparatus 4 from time to time, a rendering image will be generated according to the position and the direction of the HMD 3.

A shape of the video object is determined by a “mesh,” and a color of the surface of the video object is determined by the image (texture image) referenced by the “image” by referencing a “material,” a “texture,” and the “image” from the “mesh.” Therefore, a “node” that refers to the “mesh” is the node (joint) corresponding to the video object.

The position of the object (x, y, z) is not shown in FIG. 11, but can be described using a Translation field defined in the glTF.

As shown in FIG. 11, each node (joint) in the glTF can define an extras field and an extensions area as an extension area, and extension data can be stored in each area.

Compared to the use of the extras field, the use of the extensions area allows a plurality of attribute values to be stored in a unique area with its own name. That is, it is possible to label (name) a plurality of pieces of data stored in the extension area. Then, by filtering using the name of the extension area as a key, it is possible to clearly distinguish it from other extended information and process it.

As shown in FIG. 11, in this embodiment, various tactile-related information is stored in the extension area of a “scene” hierarchy node 26, a “node” hierarchy node 27, and a “material” hierarchy node 28, depending on an applicability and a usage. In addition, a “texture for tactile representation” is constructed, and the link information to the texture map for the tactile representation is described.

The extension area of the “scene” hierarchy stores the basic temperature and the basic surface roughness of the scene.

The extension area of the “node” hierarchy stores the basic temperature and the basic surface roughness of the video object.

The extension area of the “material” hierarchy stores the link information to the “texture for tactile representation.” The link information to the “texture for tactile representation” corresponds to the link information to the temperature texture map 20 and the surface roughness texture map 22.

As shown in FIG. 11, by storing the sensory representation metadata in the extension area of each hierarchy, hierarchical tactile representation is possible, ranging from the tactile representation of the entire scene to the tactile representation of the surface of the video object in a microscopic unit, as in the example shown in FIG. 6.

It is also possible that the normal texture map for the visual presentation prepared in advance may be used as the surface roughness texture map 22. In such a case, the extension area of the “material” hierarchy stores the link information to the “texture” corresponding to the normal texture map for the visual presentation. The information whether or not the surface roughness texture map 22 is newly generated and the information that the normal texture map for the visual presentation is used as the sensory representation metadata may be stored in the extension area of the “material” hierarchy, and the like.

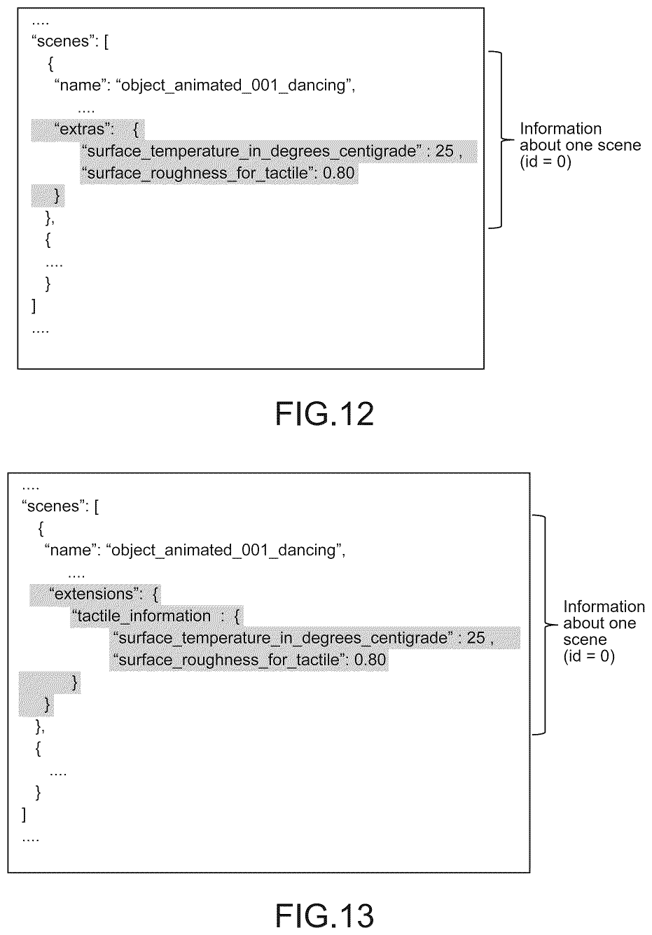

FIG. 12 is a schematic diagram showing an example of a description in the glTF if the extras field specified in the glTF is used as a method of assigning the basic temperature and the basic surface roughness of the scene to the “scene” hierarchy node 26.

In the “scenes,” the information about the “scene” is lined up. In the “scene” whose name (name) is object_animated_001_dancing and which is identified by id=0, the extras field is described and two pieces of attribute information are stored.

One attribute information is attribute information whose field name is surface_temperature_in_degrees_centigrade and its value is set to 25. This attribute information corresponds to the basic temperature of the scene and indicates that the temperature of the entire scene corresponding to the “scene” is 25° C.

The other attribute information is attribute information whose field name is surface_roughness_for_tactile and a value relating to the surface roughness to be applied to the entire scene corresponding to the “scene” is set to 0.80. This attribute information corresponds to the basic surface roughness of the scene and indicates that the roughness coefficient used when generating the height map 24 is 0.80.

FIG. 13 is a schematic diagram showing an example of the description in the glTF if the extensions area specified in the glTF is used as the method of assigning the basic temperature and the basic surface roughness of the scene to the “scene” hierarchy node 26.

Information about the “scenes” is lined up in “scenes.” In the “scene” whose name is object_animated_001_dancing and is identified by id=0, the extensions area is described.

The extensions area further defines an extension field whose name (name) is tactile_information. Two pieces of attribute information corresponding to the basic temperature and the surface roughness of the scene are stored in this extension field. Here, the same two pieces of attribute information are stored as the attribute information stored in the extras field shown in FIG. 13.

As illustrated in FIGS. 12 and 13, it is possible to describe metadata for tactile presentation for each scene. That is, for each scene, it is possible to describe the basic temperature of the scene and the basic surface roughness of the scene in the glTF as the sensory representation metadata.

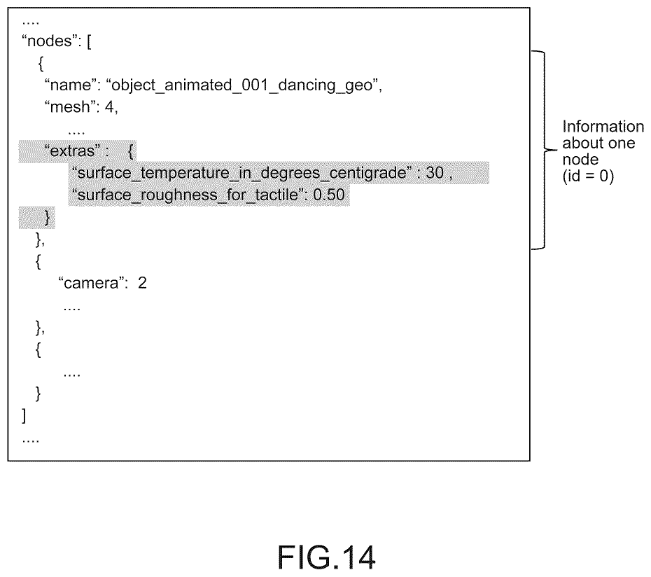

FIG. 14 is a schematic diagram showing an example of a description in the glTF if the extras field specified in the glTF is used as the method of assigning the basic temperature and the basic surface roughness of the video object to the node 27 in the “node” hierarchy.

In the “nodes,” information about the “node” is lined up. The “node” whose name (name) is object_animated_001_dancing_geo and which is identified by id=0 refers to the “mesh,” indicating that it is the video object with a shape (geometry information) in the virtual space S. The extras field is described in the “node” that defines this video object, and two pieces of attribute information are stored.

One attribute information is the attribute information whose field name is surface_temperature_in_degrees_centigrade and its value is set to 30. This attribute information corresponds to the basic temperature of the video object and indicates that the temperature of the video object corresponding to the “node” is 30° C.

The other attribute information is the attribute information whose field name is surface_roughness_for_tactile, and 0.50 is set as the value relating to the surface roughness to be applied to the video object corresponding to “node.” The attribute information corresponds to the basic surface roughness of the video object and indicates that the roughness coefficient used when generating the height map 24 is 0.50.

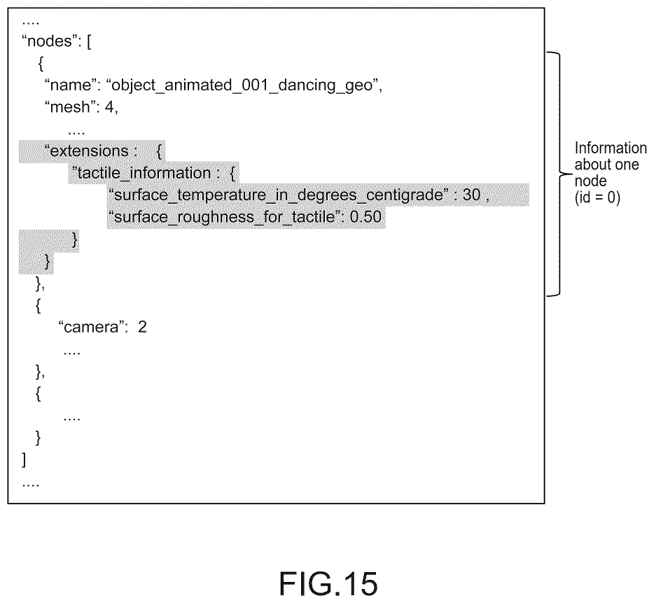

FIG. 15 is a schematic diagram showing an example of a description in the glTF if the extensions area specified in the glTF is used as the method of assigning the basic temperature and the basic surface roughness of the video object to the node 27 in the “node” hierarchy.

Information about the “node” is lined up in the “nodes. The “node” whose name (name) is object_animated_001_dancing_geo and which is identified by id=0, the extensions area is described.

The extensions area further defines an extension field whose name (name) is tactile_information. In the extension field, two pieces of attribute information corresponding to the basic temperature and the surface roughness of the video object are stored. Here, the same two pieces of attribute information are stored as the attribute information stored in the extras field shown in FIG. 14.

As illustrated in FIG. 14 and FIG. 15, it is possible to describe the metadata for the tactile presentation for each video object. That is, for each video object scene, it is possible to describe the basic temperature and the basic surface roughness of the video object in the glTF as the sensory representation metadata.

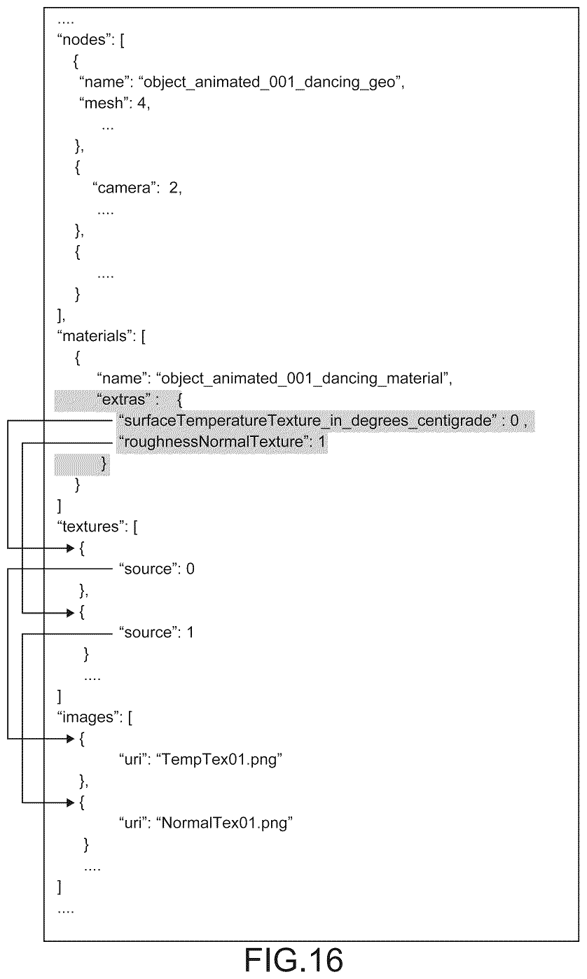

FIG. 16 is a schematic diagram showing an example of a description in the glTF if the extras field specified in the glTF is used as a method of assigning the link information to the texture map for the tactile representation to the node 28 in the “material” hierarchy.

The “material” whose name (name) is object_animated_001_dancing_material defines the extras field, and two pieces of attribute information: surfaceTemperatureTexture_in_degrees_centigrade and roughnessNormalTexture are stored.

The surfaceTemperatureTexture_in_degrees_centigrade is a pointer that refers to the temperature texture map 20 that represents the surface temperature distribution, and the type (Type) is glTF compliant textureInfo.

In the example shown in FIG. 16, the value 0 is set, which represents a link to “texture” with id=0. In the “texture” with id=0, a source of id=0 is set, which designates the “image” with id=0.

The “image” with id=0 shows a texture in a PNG format with uri, indicating that TempTex01.png is a texture file that stores information on the surface temperature distribution of the video object. In this example, TempTex01.png is used as the temperature texture map 20.

roughnessNormalTexture is a pointer that refers to the surface roughness texture map 22 that represents the surface roughness distribution, and its type (Type) is glTF compliant material.normalTextureInfo.

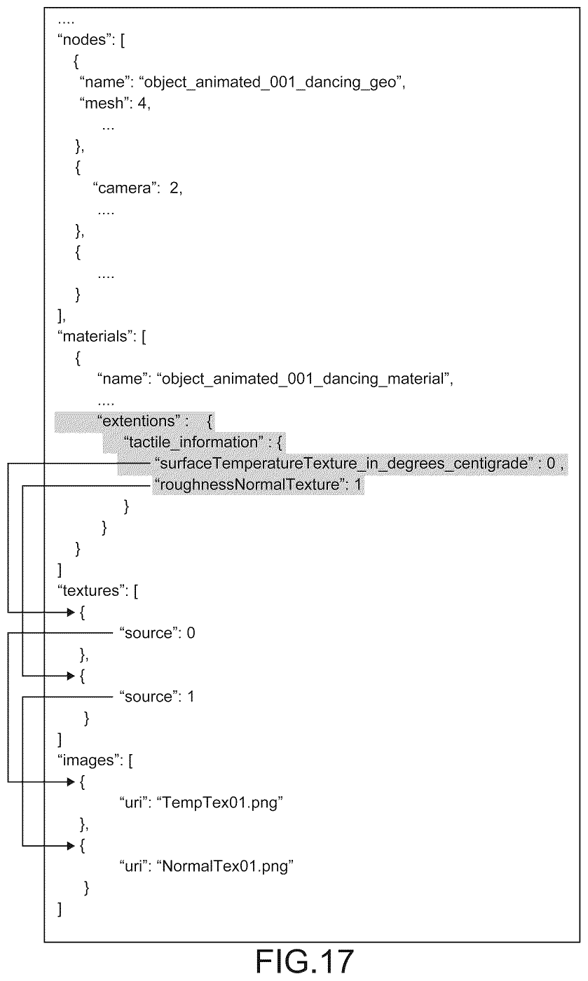

In the example shown in FIG. 17, the value 1 is set, which represents a link to “texture” with id=1. In the “texture” with id=1, a source of id=1 is set, which designates the “image” with id=1.

The “image” with id=1 shows a normal texture in the PNG format with uri, indicating that NormalTex01.png is a texture file that stores information on the surface roughness distribution of the video object. In this example, NormalTex01.png is used as the surface roughness texture map 22.

FIG. 17 is a schematic diagram showing an example of a description in the glTF if the extensions area specified in the glTF is used as the method of assigning the link information to the texture map for the tactile representation to the node 28 in the “material” hierarchy.

To the “material” whose name (name) is object_animated_001_dancing_material, the extensions area is defined.

To the extensions area, an extension field whose name (name) is tactile_information is further defined. In this extension field, two pieces of attribute information are stored, i.e., the link information to the temperature texture map 20 and the link information to the surface roughness texture map 22. Here, the same attribute information is stored as the attribute information stored in the extras field shown in FIG. 17.

As illustrated in FIGS. 16 and 17, it is possible to describe in the glTF the method of designating the texture map for the tactile representation showing the surface state of the video object in detail.

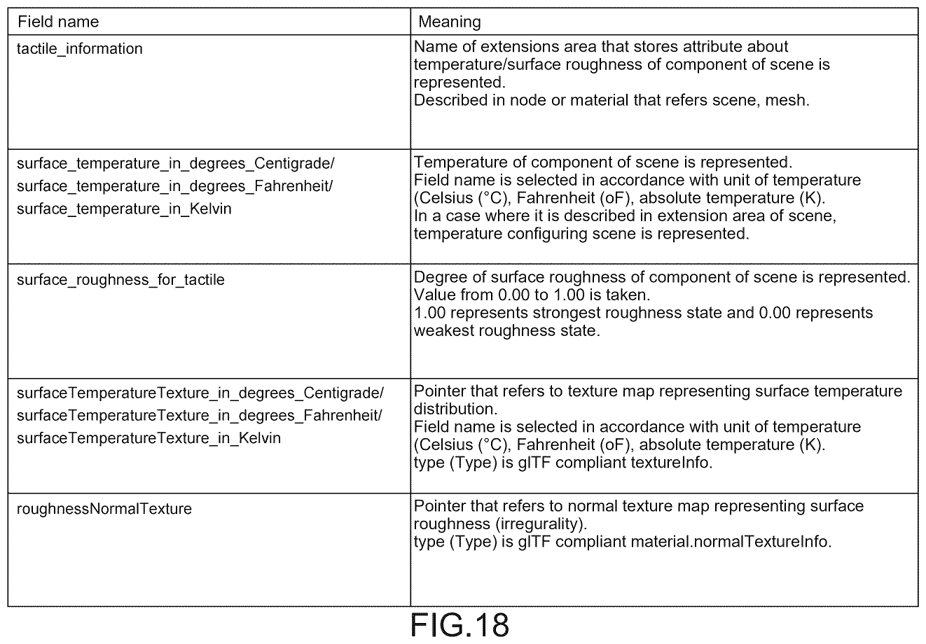

FIG. 18 is a table summarizing the attribute information relating to the representation of the temperature and the surface roughness of the component of the scene. In the examples shown in FIG. 12 through FIG. 17, the unit of a temperature is Celsius (° C.), but the field names are selected as appropriate, corresponding to the unit of a temperature to be described (Celsius (Centigrade) (° C.), Fahrenheit (° F.), absolute temperature (Kelvin) (K)). It should be appreciated that it is not limited to the attribute information shown in FIG. 18.

In this embodiment, the “scene” hierarchy node 26 shown in FIG. 11 corresponds to an embodiment of a node corresponding to a scene configured by the three-dimensional space. Also, the node 27, which refers to the “mesh” in the “node” hierarchy, corresponds to an embodiment of a node corresponding to the three-dimensional video object.

The “material” hierarchy node 28 corresponds to an embodiment of a node corresponding to the surface state of the three-dimensional video object.

In this embodiment, at least one of the basic temperature or the basic surface roughness of the scene is stored as the sensory metadata at the “scene” hierarchy node 26.

At least one of a basic temperature or basic surface roughness of the three-dimensional video object is stored as the sensory representation metadata at the node 27, which refers to the “mesh” in the “node” hierarchy.

At the node 28 of the “material” hierarchy, at least one of the link information to the temperature texture map 20 or the link information to the surface roughness texture map 22 is stored as the sensory representation metadata.

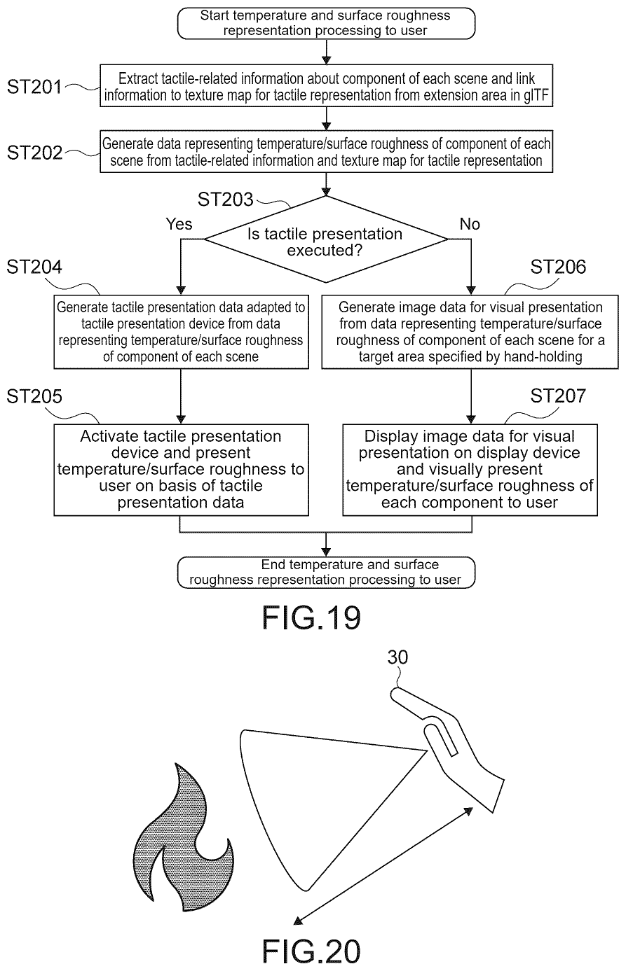

FIG. 19 is a flowchart showing an example of the temperature and the surface roughness representation processing by the representation processing section 16 of the client apparatus 4.

First, the tactile-related information about the component of each scene and the link information to the texture map for the tactile representation are extracted from the extension area (extras field/extensions area) of the scene description information in the glTF (Step 201).

From the extracted tactile-related information and the texture map for the tactile representation, data representing the temperature and the surface roughness of the component of each scene is generated (Step 202). For example, data to present the temperature and the surface roughness described in the scene description information to the user 6 (specific temperature values, or the like), temperature information indicating the temperature distribution on the surface of the video object, and irregularity information (height map) indicating the surface roughness of a video object surface are generated. The texture map for the tactile representation may be used as-is as the data representing the temperature and the surface roughness.

It is determined whether or not to execute the tactile presentation (Step 203). That is, it is determined whether or not to execute the presentation of the temperature and the surface roughness to the user 6 via the tactile presentation device.

If the tactile presentation is executed (Yes in Step 203), the tactile presentation data adapted to the tactile presentation device is generated from the data representing the temperature and the surface roughness of the component of each scene (Step 204).

The client apparatus 4 is communicatively connected to the tactile presentation device and is capable of acquiring the information about the specific data format, and the like for executing the control to present the temperature and the surface roughness in advance. In Step 204, specific tactile presentation data is generated to realize the temperature and the surface roughness to be presented to the user 6.

On the basis of the tactile presentation data, the tactile presentation device is activated and the temperature and the surface roughness are presented to the user 6 (Step 205). Thus, the tactile presentation device used by the user 6 is controlled by the representation processing section 16 of the client apparatus 4 such that at least one of the temperature or the surface roughness of the component of each scene is represented.

[Presentation of Temperature and Surface Roughness Via Sense Other than Sense of Tactile (Sense of Skin)]

In Step 203, the case in which no tactile presentation is executed is described.

In the virtual space provision system 1 according to this embodiment, it is possible to provide the user 6 with the temperature and the surface roughness with respect to the component of the scene. On the other hand, it may be necessary to present the temperature and the surface roughness to the user 6 in a sense other than the sense of tactile (sense of skin).

For example, there may be a case in which the user 6 does not wear the tactile presentation device. Even if the user 6 wears the tactile presentation device, there may be a case in which the user 6 wants to know the temperature or the surface roughness of the object before touching the surface of the video object with the hand. In addition, there may also be a case in which it needs to present the temperature or the surface roughness that is difficult to reproduce with the tactile presentation device worn by the user 6. For example, there may be a case in which the tactile presentation device that can present temperatures has a limited range of temperatures that can be presented, and it is necessary to inform the user of temperatures that exceed that range.

There may also be a case in which a condition of the temperature or the surface roughness is one that should not be presented to the user 6. For example, there may be many cases in which it is not appropriate to present a high or low temperature condition that would be uncomfortable or dangerous to the user 6. It should be appreciated that there could be

a design in which one with a high temperature that is dangerous for a human to touch are not created in the artificial virtual space S in the first place. On the other hand, since it is important to reproduce the real space as faithfully as possible in a digital twin, it is quite possible that the virtual space S is designed to represent a hot object as hot and a cold object as cold.

With this in mind, the present inventor has also devised a new alternative presentation that makes it possible to perceive the temperature and the surface roughness of the component of the scene with other senses.

The determination of Step 203 is executed on the basis of whether or not the user 6 is wearing the tactile presentation device, for example. Alternatively, it may be executed on the basis of whether or not the tactile device that the user 6 is wearing is valid (temperature and surface roughness are within range that can be presented). Alternatively, a tactile presentation mode and an alternative presentation mode with other senses may be switched by an input from the user 6. For example, the tactile presentation mode and the alternative presentation mode may be switched by a sound input from the user 6.

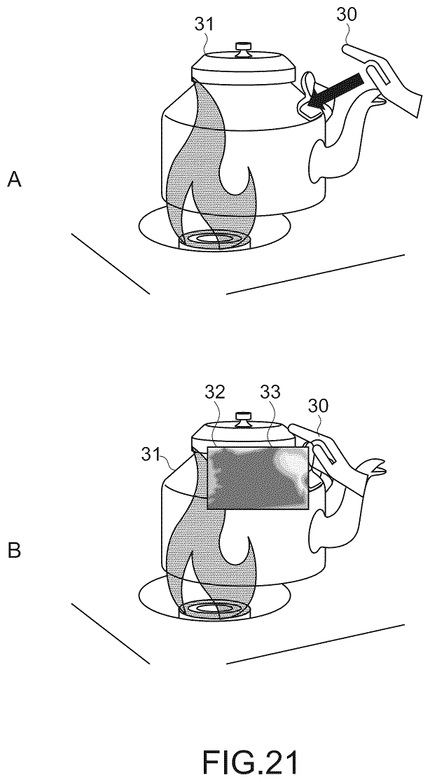

FIGS. 20 and 21 are schematic diagrams showing an example of the alternative presentation mode via senses other than the sense of tactile.

As shown in FIG. 20, if the tactile presentation is not executed (No in Step 203), presence or absence of “hand-holding” using a hand 30 of the user 6 is determined. That is, in this embodiment, the presence or absence of a gesture input of the “hand-holding” is adopted as a user interface when the alternative presentation mode is executed.

In Step 206 of FIG. 19, image data for visual presentation is generated from the data representing the temperature and the surface roughness of the component of each scene for a target area specified by the “hand-holding” of the user 6.

Then, in Step 207 of FIG. 19, the image data for the visual presentation is displayed on a display that can be viewed by the user 6, such as the HMD 3. This makes it possible to present the temperature and the surface roughness of each component of the scene to the user 6 via the sense of sight, which is a different sense from the sense of tactile (sense of skin).

In the example shown in A of FIG. 21, a scene is displayed in the virtual space S in which the video object, a kettle 31, is exposed to high temperature. In such a state, the “hand-holding” is performed by the user 6 by bringing the hand 30 close to the kettle 31. That is, from the state in which the hand 30 is away from the kettle 31 shown in A of FIG. 21, the hand 30 is brought closer to the kettle 31 as shown in B of FIG. 21.

The representation processing section 16 of the client apparatus 4 generates image data for visual presentation 33 for the target area 32 specified by the “hand-holding.” Then, the rendering processing by the rendering section 14 is controlled such that the target area 32 is displayed with the image data for the visual presentation 33. The rendering video 8 generated by the rendering processing is displayed on the HMD 3. As a result, the virtual video in which the target area 32 is displayed by the image data for the visual presentation 33 is displayed to the user 6, as shown in B of FIG. 21.

In the example shown in B of FIG. 21, a portion of the kettle 31 that is in a very hot state is displayed with a thermography in which high and low temperatures are converted into colors. That is, a thermographic image corresponding to the temperature is generated as the image data for the visual presentation 33 for the target area 32 designated by the “hand-holding.” For example, the thermographic image is generated on the basis of the temperature texture map 20 defined in the target area 32 designated by the “hand-holding.”

The rendering processing is then controlled such that the target area 32 is displayed as the thermographic image to the user 6. This allows the user 6 to visually perceive a temperature condition of the area (target area 32) by the “hand-holding.”

An image in which the surface irregularity of the video object is converted to color is generated as the image data for the visual presentation. This makes it possible to visually present the surface roughness. For example, the surface roughness texture map or the height map generated from the surface roughness texture map may be converted to a color distribution. Alternatively, the normal texture map for the visual presentation can be visualized as it is as the surface roughness texture map 22. This allows visualization of the minute irregularity that are not reflected in the geometry, consistent with tactile presentation.

By adopting the “hand-holding” as the user interface, the user 6 can easily and intuitively specify the area where the user 6 wants to know the surface state (temperature and surface roughness). That is, the “hand-holding” is considered to be the user interface that is easy for a human to handle. For example, when the user moves the hand close to the surface, a narrow area is visually presented, and when the user moves the hand away from the surface, a wide area of the surface state is presented. Furthermore, when the hand is moved away, the visual presentation of the surface state ends (visual image data disappears). Such processing is also possible.

For example, a threshold value may be set with respect to a distance between the video object and the hand 30 of the user 6, and with reference to the threshold value, the presence or absence of the visual presentation of the temperature and the surface roughness may be determined.

A thermographic apparatus is also used in the real space to visualize the temperature of the object. This apparatus uses a thermographic display to represent the temperature in terms of a display color of an object, to thereby visually perceiving the temperature.

As illustrated in B of FIG. 21, it is possible to adopt the thermographic display as the alternative presentation in the virtual space S. In this case, if the thermographic display is not limited to which range of the video object, there could be a problem that the entire scene becomes the thermographic display and a normal color display is hidden.

Alternatively, a virtual thermography apparatus can be prepared in the virtual space S and the temperature of the video object may be observed by the color through the apparatus. In this case, as when using the apparatus in the real space, the temperature distribution in the measurement range defined by a specification of the apparatus can be visually known.

On the other hand, as in the real space, it is necessary to take out (display) the virtual device corresponding to the thermography in the virtual space S, hold it in the hand, and direct it at the object to be measured.

If the virtual device with the same control system as in the real space is used, the same restrictions that occur in the real space also occur in the virtual space, such as the hands being occupied and not being able to perform other operations.

In the real space, the temperature can be measured using a physical sensing device such as a thermometer or the thermographic apparatus, but there is no necessity to measure the temperature in the virtual space S in the same way as in the real space. Also, a presentation method of a measurement result does not have to be the same as a presentation method used in the real space.

In this embodiment, the gesture input of the “hand-holding” allows to easily and intuitively perceive the temperature and the surface roughness with respect to a desired area of the surface of the video object.

In addition to the visual representation of the temperature and the surface roughness, it is also possible to present the temperature and the surface roughness via the sense of hearing. For example, when the user 6 holds the hand over the video object, a beep sound is generated.

For example, a high/low frequency and a repetition cycle (beep, beep, beep . . . ) of the beep sound are controlled to correspond to the surface temperature. This allows the user 6 to perceive the temperature by the sense of hearing. In addition, the high/low frequency and the repetition cycle (beep, beep, beep . . . ) of the beep sound are controlled according to the height of the surface irregularity. This allows the user 6 to perceive the surface roughness by the sense of hearing. It should be appreciated that it is not limited to the beep sound and any sound notification corresponding to the temperature and the surface roughness may be adopted.

The image data for the visual presentation 33 illustrated in B of FIG. 21 corresponds to an embodiment according to the present technology of a representation image in which at least one of the temperature and the surface roughness of the component is visually represented. The representation processing section 16 controls the rendering processing by the rendering section 14 such that the representation image is included.

The “hand-holding” shown in FIG. 20 corresponds to an embodiment of the input from the user 6. On the basis of the input from the user 6, the target area in which at least one of the temperature or the surface roughness is represented for the component is set, and the rendering processing is controlled such that the target area is displayed by the representation image.

A user input to specify the alternative presentation mode that presents the temperature and the surface roughness via other senses, such as the sense of sight or the sense of hearing, and the user input to specify the target area for the alternative presentation are not limited, and any input method may be adopted, including any sound input, any gesture input, and the like.

For example, when the sound input of a “temperature display” is followed by the “hand-holding,” the thermographic display of the target area specified by the “hand-holding” is executed. Alternatively, when the sound input of a “surface roughness display” is followed by the “hand-holding,” an image display with color-converted irregularity for the target area specified by the “hand-holding” is executed. This kind of setting is also possible.

An input method for indicating an end of the alternative presentation of the temperature and the surface roughness is also not limited. For example, processing is possible such that, in response to the sound input such as “stop temperature display,” the thermographic display shown in B of FIG. 21 is presented, and an original surface color display is returned.

In this embodiment, stimulation received by the sense of tactile (sense of skin) can be perceived by other senses such as the sense of sight and the sense of hearing, which is very effective in terms of accessibility in the virtual space S.

As described above, in the virtual space provision system 1 according to this embodiment, the broadcasting server 2 generates the three-dimensional spatial data including the sensory representation metadata that represents at least one of the temperature or the surface roughness with respect to the component of the scene configured of the three-dimensional space. The client apparatus 4 represents at least one of the temperature or the surface roughness with respect to the component of the scene configured by the three-dimensional space on the basis of the three-dimensional spatial data. This makes it possible to realize the high-quality virtual video.

A method of determining the temperature of the video object and the like in the virtual space S is to calculate the temperature using physics-based rendering. This method calculates the temperature of the video object by heat energy emitted from inside the video object and ray tracing light rays or heat rays irradiated to the video object. Focusing on the surface temperature of the video object existing in the three-dimensional virtual space, the temperature depends not only on the heat generated inside, but also on the outside temperature and irradiation intensity of illumination light.

By executing the physics-based rendering, it is possible to reproduce the surface temperature of the video object with very high accuracy, but physical rendering of the light rays requires a huge amount of computation, and in addition, physical rendering of the temperature is a large processing load.

In the virtual space provision system 1 according to this embodiment, the three-dimensional virtual space is regarded as a kind of content, and the environmental temperature in the scene and the temperature distribution of each object are described and stored as the attribute information (metadata) in the scene description information, which is a blueprint for the three-dimensional virtual space. This newly devised method of using content metadata makes it possible to greatly simplify the representation of the temperature and the surface roughness in the three-dimensional virtual space, thereby reducing the processing load. It should be appreciated that the method of using the content metadata according to this embodiment and the method of calculating the temperature by the physical-based rendering, and the like may be used together.

By applying the present technology, it is possible to realize a content broadcasting system that converts the surface state (temperature and surface roughness) of the video object in the three-dimensional virtual space S into data and broadcasts it, which can perceive the surface state of the video object with the tactile presentation device as well as the visual presentation of the video object by the client apparatus 4.

This makes it possible to present the surface state of the virtual object to the user 6 when the user 6 touches the virtual object in the three-dimensional virtual space S. As a result, the user 6 can feel the virtual object more realistically.

By applying the present technology, it is possible to store sensory display metadata necessary for the presentation of the surface state of the video object as the attribute information for the video object or part of the video object, in the extension area of the glTF, which is the scene description.

This makes it possible to reproduce the surface state of the object specified by the content creator during three-dimensional virtual space presentation (during content reproduction). For example, the surface state of the video object can be set for each video object or part thereof (mesh, vertex), enabling a more realistic representation. It also enables circulation of the content containing tactile presentation information.

By applying the present technology, it is possible to define and store the temperature texture map for the tactile presentation as information representing the temperature distribution on the surface of the video object.

This makes it possible to represent the temperature distribution on the surface of the video object without affecting (without modifying data) the geometry information of the video object and the texture map of the color information (such as albedo).

By applying the present technology, it is possible to define and store the surface roughness texture map for the tactile presentation as information of the roughness (irregularity) distribution of the video object surface. Alternatively, an existing normal texture map for visual presentation can be used as the surface roughness texture map for the tactile presentation.

This makes it possible to represent the minute irregularity on the surface of the video objejut without increasing the geometry information. Since the geometry is not reflected during the rendering processing, it is possible to suppress the increase in the rendering processing load.

By applying the present technology, it is possible to specify the area where the surface state of the video object is to be visualized by the “hand-holding.”

This makes it possible to easily know the surface state of the video object without having to prepare or hold a tool for detecting the surface state of video object.

By applying the present technology, it is possible to visualize the surface state of the video object by changing the color of the video object on the basis of the texture map representing the surface state (high/low temperature or degree of surface roughness).

This makes it possible to visually perceive the surface state of the video object. For example, it is possible to soften a shock caused by a sudden touch of a hot or cold object.

By applying the present technology, it is possible to represent the surface state of the video object by a tone and high/low of the sound.

This makes it possible to perceive the surface state of the video object with the sense of hearing. For example, it is possible to soften the shock caused by the sudden touch of the hot or cold object.

### Other Embodiments

The present technology is not limited to the embodiments described above, and various other embodiments can be realized.

The above describes an example in which the information for the visually presenting the surface temperature and the surface roughness of the video object to the user 6 (as alternative to tactile presentation) is generated by client processing from the texture map used for the tactile presentation. It is not limited to this, a content creator side may separately provide the texture map to be visually presented to the user 6 as an alternative to the tactile presentation, in addition to the texture map used for the tactile presentation.

In this case, for example, in the extension area (extras field/extensions area) of the “material” hierarchy node 28 in FIG. 16 and FIG. 17, for example, surfaceTemperatureVisualize and roughnessNormalTextureVisualize may be defined and have a link (accessor) to the texture map for the visual presentation.

In the scene description information, an independent node may be newly defined to collectively store the sensory representation metadata. For example, the basic temperature and the basic surface roughness of the scene, the basic temperature and the basic roughness of the video object, and the link information to the texture map for the tactile presentation may be associated with a scene id, a video object id, and the like and stored in the extension area of the independent node (extras field/extensions area).

In the example shown in FIG. 1, the three-dimensional spatial data including the sensory representation metadata is generated by the broadcasting server 2. It is not limited to this, the three-dimensional spatial data including the sensory representation metadata may be generated by other computers and provided to the broadcasting server 2.

In FIG. 1, a configuration example of a client-side rendering system is adopted as the broadcasting system for the 6DoF video. It is not limited to this, other broadcasting system configurations such as a server-side rendering system may be adopted as the broadcasting system for the 6DoF video to which the present technology can be applied.

It is also possible to apply the present technology to a remote communication system that enables a plurality of the users 6 to communicate by sharing the three-dimensional virtual space S. Each user 6 can experience the temperature and the surface roughness of the video object, enabling each other to share and enjoy the highly realistic virtual space S.

In the above, the case in which the 6DoF video including 360-degree spatial video data, or the like is broadcasted as the virtual image is given as an example. It is not limited to this, and the present technology is also applicable if a 3DoF video, a 2D video, and the like are broadcasted. In addition, as the virtual image, an AR video and the like may be broadcasted instead of the VR video. The present technology is also applicable to a stereo video (for example, right eye image and left eye image) for viewing the 3D image.

FIG. 22 is a block diagram showing an example of a hardware configuration of a computer (information processing apparatus) 60 that can realize the broadcasting server 2 and the client apparatus 4.

The computer 60 includes a CPU 61, a ROM 62, a RAM 63, an input/output interface 65, and a bus 64 that connects them to each other. The input/output interface 65 is connected to a display section 66, an input section 67, a storage section 68, a communication section 69, and a drive section 70, and the like.

The display section 66 is a display device using, for example, a liquid crystal, an EL, and the like. The input portion 67 is a keyboard, a pointing device, a touch panel, or other operating device, for example. If the input section 67 includes a touch panel, the touch panel can be integrated with the display section 66.

The storage section 68 is a non-volatile storage device, for example, an HDD, a flash memory, or other solid-state memory. The drive section 70 is a device capable of driving a removable recording medium 71, for example, an optical recording medium, a magnetic recording tape, and the like.

The communication section 69 is a modem, a router, or other communication device that can be connected to a LAN or a WAN to communicate with other devices. The communication section 69 may use either wired or wireless communication. The communication section 69 is often used separately from the computer 60.

Information processing by the computer 60 having the above hardware configuration is realized by cooperation of software stored in the storage section 68, the ROM 62, or the like and hardware resources of the computer 60. Specifically, the information processing method (generation method and reproduction method) according to the present technology is realized by loading and executing a program configuring the software, which is stored in the ROM 62 or the like into the RAM 63.

The program is installed on the computer 60 via the recording medium 61, for example. Alternatively, the program may be installed on the computer 60 via a global network or other means. Any other computer-readable, non-transitory storage medium may be used.

The information processing method (generation method and reproduction method) and the program according to the present technology may be executed by cooperation of a plurality of computers connected communicatively via a network or the like to construct the information processing apparatus according to the present technology.

That is, the information processing method (generation method and reproduction method) and the program according to the present technology can be executed not only by a computer system configured of a single computer, but also by a computer system in which a plurality of computers work in conjunction with each other.

In the present disclosure, the system means a set of a plurality of components (such as apparatuses, modules (parts)), regardless of whether or not all components are in the same enclosure. Thus, a plurality of apparatuses housed in separate enclosures and connected via a network, and a plurality of modules housed in a single enclosure are all the system.

In the information processing method (generation method and reproduction method) and the program according to the present technology by the computer system, for example, generation of the three-dimensional spatial data including the sensory representation metadata, storage of the sensory representation metadata in the extension area in the glTF, generation of the temperature texture map, generation of the surface roughness texture map, generation of the height map, representation of the temperature and the surface roughness, generation of the image data for the visual presentation, presentation of the temperature and the surface roughness via sound, or the like is executed by a single computer or by a different computer for each processing. Thus, both cases are included. The execution of each processing by a predetermined computer also includes having another computer execute part or all of the processing and acquiring results.

That is, the information processing method (generation method and reproduction apparatus) and the program according to the present technology can be applied to a cloud computing configuration in which a single function is shared and processed jointly by a plurality of apparatuses via a network.

Each configuration and each processing flow of the virtual space provision system, the client-side rendering system, the broadcasting server, the client apparatus, the HMD, and the like described with reference to the drawings are only embodiments, and can be arbitrarily transformed to the extent not to depart from the intent of the present technology. That is, any other configuration, algorithm, and the like may be adopted to implement the present technology.

In the present disclosure, to help understand the descriptions, the terms “substantially”, “approximately”, “roughly”, and the like are used as appropriate. Meanwhile, no clear difference is defined between a case where these terms “substantially”, “approximately”, “roughly”, and the like are used and a case where the terms are not used.

In other words, in the present disclosure, a concept defining a shape, a size, a positional relationship, a state, and the like such as “center”, “middle”, “uniform”, “equal”, “same”, “orthogonal”, “parallel”, “symmetric”, “extend”, “axial direction”, “circular cylinder shape”, “cylindrical shape”, “ring shape”, and “circular ring shape” is a concept including “substantially at the center”, “substantially in the middle”, “substantially uniform”, “substantially equal”, “substantially the same”, “substantially orthogonal”, “substantially parallel”, “substantially symmetric”, “extend substantially”, “substantially the axial direction”, “substantially the circular cylinder shape”, “substantially the cylindrical shape”, “substantially the ring shape”, “substantially the circular ring shape”, and the like.

For example, a state within a predetermined range (e.g., range within ±10%) that uses “completely at the center”, “completely in the middle”, “completely uniform”, “completely equal”, “completely the same”, “completely orthogonal”, “completely parallel”, “completely symmetric”, “extend completely”, “completely the axial direction”, “completely the circular cylinder shape”, “completely the cylindrical shape”, “completely the ring shape”, “completely the circular ring shape”, and the like as a reference is also included.

Accordingly, even when the terms “substantially”, “approximately”, “roughly”, and the like are not added, what you might call a concept that may be expressed by adding “substantially”, “approximately”, “roughly”, and the like may be included. Conversely, a complete state is not necessarily excluded regarding the state expressed by adding “substantially”, “approximately”, “roughly”, and the like.

In the present disclosure, expressions that use “than” as in “larger than A” and “smaller than A” are expressions that comprehensively include both of a concept including a case of being equal to A and a concept not including the case of being equal to A. For example, “larger than A” is not limited to a case that does not include equal to A and also includes “A or more”. In addition, “smaller than A” is not limited to “less than A” and also includes “A or less”.

In embodying the present technology, specific settings and the like only need to be adopted as appropriate from the concepts included in “larger than A” and “smaller than A” so that the effects described above are exerted.

Of the feature portions according to the present technology described above, at least two of the feature portions can be combined. In other words, the various feature portions described in the respective embodiments may be arbitrarily combined without distinction of the embodiments. Moreover, the various effects described above are mere examples and are not limited, and other effects may also be exerted.

It is noted that the present technology can also take the following configurations.

(1) A generation apparatus, including:
a generation section that generates three-dimensional spatial data used in rendering processing executed to represent a three-dimensional space and including sensory representation metadata for representing at least one of a temperature or surface roughness with respect to a component of a scene configured by the three-dimensional space.
   (2) The generation apparatus according to (1), in which
the three-dimensional spatial data includes scene description information that defines a configuration of the three-dimensional space and three-dimensional object data that defines a three-dimensional object in
the three-dimensional space, and the generation section generates at least one of the scene description information including the sensory representation metadata or the three-dimensional object data including the sensory representation metadata.
   (3) The generation apparatus according to (2), in which
the generation section generates the scene description information including at least one of a basic temperature or basic surface roughness of the scene configured by the three-dimensional space as the sensory representation metadata.
   (4) The generation apparatus according to (2) or (3), in which
the three-dimensional object data includes video object data that defines a three-dimensional video object in the three-dimensional space, and
the generation section generates the scene description information including at least one of a basic temperature or basic surface roughness of the three-dimensional video object as the sensory representation metadata.
   (5) The generation apparatus according to any one of (2) to (4), in which
the three-dimensional object data includes the video object data that defines the three-dimensional video object in the three-dimensional space, and
the generation section generates at least one of a temperature texture for representing the temperature or a surface roughness texture for representing the surface roughness as the sensory representation metadata with respect to a surface of the three-dimensional video object.
   (6) The generation apparatus according to (5), in which
the video object data includes a normal texture used to visually represent the surface of the three-dimensional video object, and
the generation section generates the surface roughness texture on a basis of the normal texture.
   (7) The generation apparatus according to any one of (2) to (6), in which
a data format of the scene description information is a glTF (GL Transmission Format).
   (8) The generation apparatus according to (7), in which
the three-dimensional object data includes the video object data that defines the three-dimensional video object in the three-dimensional space, and
the sensory representation metadata is stored in at least one of an extension area of a node corresponding to the scene configured by the three-dimensional space, an extension area of a node corresponding to the three-dimensional video object, or an extension area of a node corresponding to a surface state of the three-dimensional video object.
   (9) The generation apparatus according to (8), in which
in the scene description information, at least one of a basic temperature or basic surface roughness of the scene is stored as the sensory representation metadata in the extension area of the node corresponding to the scene.
   (10) The generation apparatus according to (8) or (9), in which
in the scene description information, at least one of a basic temperature or basic surface roughness of the three-dimensional video object is stored as the sensory representation metadata in the extension area of the node corresponding to the three-dimensional video object.
   (11) The generation apparatus according to any one of (8) through (10), in which
in the scene description information, at least one of link information to the temperature texture for representing the temperature or link information to the surface roughness texture for representing the surface roughness is stored as the sensory representation metadata in the extension area of the node corresponding to the surface state of the three-dimensional video object.
   (12) A generation method executed by a computer system, including:
generating three-dimensional spatial data that is used in rendering processing executed to represent a three-dimensional space and that includes sensory representation metadata for representing at least one of a temperature or surface roughness with respect to a component of a scene configured by the three-dimensional space.
   (13) A reproduction apparatus, including:
a rendering section that generates two-dimensional video data in which a three-dimensional space is represented corresponding to a field of view of a user by executing rendering processing on three-dimensional spatial data on a basis of field of view information about the field of view of the user; and
a representation processing section that represents at least one of a temperature or surface roughness with respect to a component of a scene configured by the three-dimensional space on a basis of the three-dimensional spatial data.
   (14) The reproduction apparatus according to (13), in which
the representation processing section represents at least one of the temperature or the surface roughness on a basis of sensory representation metadata included in the three-dimensional spatial data, the sensory representation metadata representing at least one of the temperature or the surface roughness with respect to the component of the scene configured by the three-dimensional space.
   (15) The reproduction apparatus according to (13) or (14), in which
the representation processing section controls a tactile presentation device used by the user such that at least one of the temperature or the surface roughness of the component is represented.
   (16) The reproduction apparatus according to any one of (13) to (15), in which
the representation processing section generates a representation image in which at least one of the temperature or the surface roughness of the component is visually represented, and controls the rendering processing by the rendering section to include the representation image.
   (17) The reproduction apparatus according to (16), in which
the representation processing section sets a target area in which at least one of the temperature or the surface roughness is represented for the component on a basis of an input from the user, and controls the rendering processing such that the target area is displayed by the representation image.
   (18) A reproduction method executed by a computer system, including:
generating two-dimensional video data in which a three-dimensional space is represented corresponding to a field of view of a user by executing rendering processing on three-dimensional spatial data on a basis of field of view information about the field of view of the user; and
representing at least one of a temperature or surface roughness with respect to a component of a scene configured by the three-dimensional space on a basis of the three-dimensional spatial data.
   (19) An information processing system, including:
a generation section that generates three-dimensional spatial data used in rendering processing executed to represent a three-dimensional space and including sensory representation metadata for representing at least one of a temperature or surface roughness with respect to a component of a scene configured by the three-dimensional space;
a rendering section that generates two-dimensional video data in which a three-dimensional space is represented corresponding to a field of view of a user by executing rendering processing on the three-dimensional spatial data on a basis of field of view information about the field of view of the user; and
a representation processing section that represents at least one of a temperature or surface roughness with respect to a component of a scene configured by the three-dimensional space on a basis of the three-dimensional spatial data.

### REFERENCE SIGNS LIST

S virtual space
1 virtual space provision system
2 broadcasting server
3 HMD
4 client apparatus
6 user
8 rendering video
10 wearable controller
12 three-dimensional spatial data generation section
14 rendering section
16 representation processing section
18 video object
20 temperature texture map
22 surface roughness texture map
24 height map
26 “scene” hierarchy node
27 “node” hierarchy node
28 “material” hierarchy node
32 target area
33 image data for visual presentation
60 computer

1. A generation apparatus, comprising:
a generation section that generates three-dimensional spatial data used in rendering processing executed to represent a three-dimensional space and including sensory representation metadata for representing at least one of a temperature or surface roughness with respect to a component of a scene configured by the three-dimensional space.

2. The generation apparatus according to claim 1, wherein
the three-dimensional spatial data includes scene description information that defines a configuration of the three-dimensional space and three-dimensional object data that defines a three-dimensional object in the three-dimensional space, and
the generation section generates at least one of the scene description information including the sensory representation metadata or the three-dimensional object data including the sensory representation metadata.

3. The generation apparatus according to claim 2, wherein
the generation section generates the scene description information including at least one of a basic temperature or basic surface roughness of the scene configured by the three-dimensional space as the sensory representation metadata.

4. The generation apparatus according to claim 2, wherein
the three-dimensional object data includes video object data that defines a three-dimensional video object in the three-dimensional space, and
the generation section generates the scene description information including at least one of a basic temperature or basic surface roughness of the three-dimensional video object as the sensory representation metadata.

5. The generation apparatus according to claim 2, wherein
the three-dimensional object data includes video object data that defines the three-dimensional video object in the three-dimensional space, and
the generation section generates at least one of a temperature texture for representing the temperature or a surface roughness texture for representing the surface roughness as the sensory representation metadata with respect to a surface of the three-dimensional video object.

6. The generation apparatus according to claim 5, wherein
the video object data includes a normal texture used to visually represent the surface of the three-dimensional video object, and
the generation section generates the surface roughness texture on a basis of the normal texture.

7. The generation apparatus according to claim 2, wherein
a data format of the scene description information is a glTF (GL Transmission Format).

8. The generation apparatus according to claim 7, wherein
the three-dimensional object data includes video object data that defines the three-dimensional video object in the three-dimensional space, and
the sensory representation metadata is stored in at least one of an extension area of a node corresponding to the scene configured by the three-dimensional space, an extension area of a node corresponding to the three-dimensional video object, or an extension area of a node corresponding to a surface state of the three-dimensional video object.

9. The generation apparatus according to claim 8, wherein
in the scene description information, at least one of a basic temperature or basic surface roughness of the scene is stored as the sensory representation metadata in the extension area of the node corresponding to the scene.

10. The generation apparatus according to claim 8, wherein
in the scene description information, at least one of a basic temperature or basic surface roughness of the three-dimensional video object is stored as the sensory representation metadata in the extension area of the node corresponding to the three-dimensional video object.

11. The generation apparatus according to claim 8, wherein
in the scene description information, at least one of link information to the temperature texture for representing the temperature or link information to the surface roughness texture for representing the surface roughness is stored as the sensory representation metadata in the extension area of the node corresponding to the surface state of the three-dimensional video object.

12. A generation method executed by a computer system, comprising:
generating three-dimensional spatial data that is used in rendering processing executed to represent a three-dimensional space and that includes sensory representation metadata for representing at least one of a temperature or surface roughness with respect to a component of a scene configured by the three-dimensional space.

13. A reproduction apparatus, comprising:
a rendering section that generates two-dimensional video data in which a three-dimensional space is represented corresponding to a field of view of a user by executing rendering processing on three-dimensional spatial data on a basis of field of view information about the field of view of the user; and
a representation processing section that represents at least one of a temperature or surface roughness with respect to a component of a scene configured by the three-dimensional space on a basis of the three-dimensional spatial data.

14. The reproduction apparatus according to claim 13, wherein
the representation processing section represents at least one of the temperature or the surface roughness on a basis of sensory representation metadata included in the three-dimensional spatial data, the sensory representation metadata representing at least one of the temperature or the surface roughness with respect to the component of the scene configured by the three-dimensional space.

15. The reproduction apparatus according to claim 13, wherein
the representation processing section controls a tactile presentation device used by the user such that at least one of the temperature or the surface roughness of the component is represented.

16. The reproduction apparatus according to claim 13, wherein
the representation processing section generates a representation image in which at least one of the temperature or the surface roughness of the component is visually represented, and controls the rendering processing by the rendering section to include the representation image.

17. The reproduction apparatus according to claim 16, wherein
the representation processing section sets a target area in which at least one of the temperature or the surface roughness is represented for the component on a basis of an input from the user, and controls the rendering processing such that the target area is displayed by the representation image.

18. A reproduction method executed by a computer system, comprising:
generating two-dimensional video data in which a three-dimensional space is represented corresponding to a field of view of a user by executing rendering processing on three-dimensional spatial data on a basis of field of view information about the field of view of the user; and
representing at least one of a temperature or surface roughness with respect to a component of a scene configured by the three-dimensional space on a basis of the three-dimensional spatial data.
